(19) United States
(12) Patent Application Publication
(10) Pub. No.: US 2008/0047863 A1
(43) Pub. Date: Feb. 28, 2008

(54) Sports Ball Bag Systems

(76) Inventors: Robert L. Friou, Phoenix, AZ (US); Rudi M. Fulce, Phoenix, AZ (US)

Correspondence Address: STONEMAN LAW OFFICES, LTD, 3113 NORTH 3RD STREET, PHOENIX, AZ, 85012, US

(21) Appl. No.: 11/844,273

(22) Filed: Aug. 23, 2007

Related U.S. Application Data
(60) Provisional application No. 60/840,251, filed on Aug. 25, 2006.

(51) Int. Cl. B65D 79/00; B31B 41/00

(52) U.S. Cl. 206/457; 206/459.5; 224/153; 493/186

(57) ABSTRACT

A system and related manufacturing and business methods based on bags comprising three-dimensional representations of items necessary to sports contests.

### CROSS-REFERENCE TO RELATED APPLICATION

The present application is related to and claims priority from prior provisional application Ser. No. 60/840,251, filed Aug. 25, 2006, entitled “Sports Ball Bag Systems”, the contents of which are incorporated herein by this reference and are not admitted to be prior art with respect to the present invention by the mention in this cross-reference section.

### BACKGROUND

This invention relates to providing a system for improved apparatus and methods for providing bags configured as three-dimensional sports ball representations. Generally, people travel with personal effects (e.g., money, identification cards, credit or debit cards, lipstick, keys, documents, snack food, other personal items, etc.). For several reasons, effectively containing such items may be difficult. Setting these items down at a destination creates the risk of forgetting about such items and leaving them behind, or even having them stolen. In addition, such items may be too many or too large for placement within the pockets of one's clothing. Furthermore, keeping these items in a person's hands, at all times, clearly prevents them from having their hands free for completing tasks. For example, a fan attending a sporting event may wish to carry and have with their person, during such sporting event, money, identification cards, keys, and suntan lotion. The fan will inevitably encounter the problems of not having enough pocket space, and risks having such items lost or stolen if they are placed under stadium seats.

It is typical of sports fans that they generally have a great interest in displaying for others to view the sports and teams of their liking. Typical sports fans tend to wear hats, t-shirts, and jerseys comprising logos or trademarks representative of their preferred sports and teams. For example, New York Yankees fan and Mayor of New York, Rudolph Giuliani, has been notably photographed attending New York baseball games wearing a Yankees jacket and a Yankees hat. Historically, when sports fans have wanted to carry items with them to a game, they have had to resort to bulky and cumbersome backpacks, purses, and other bags, such bags having no sports-related representation or imagery. Further, there has not been a convenient way to allow local regional advertisers, for example within a particular city, to advertise by providing a sports-ball representation bag that assists fans in carrying their personal items.

### OBJECTS AND FEATURES OF THE INVENTION

A primary object and feature of the present invention is to provide an improved sports representation bag. It is a further object and feature of the present invention to provide such a system capable of containing a user's personal effects and other containable items. It is a further object and feature of the present invention to provide such a system providing three-dimensional sports item representation. It is a further object and feature of the present invention to provide such a system that maintains the form of the sports item represented, when the system is in tension or compression. It is a further object and feature of the present invention to provide such a system conveniently connectable to a user. It is a further object and feature of the present invention to provide such a system that limits how much it opens, in order to prevent personal effects and other containable items from falling out.

It is a further object and feature of the present invention to provide such a system capable of being worn comfortably when attached to a user. It is a further object and feature of the present invention to provide such a system capable of adjusting such that it fits different size users. It is a further object and feature of the present invention to provide such a system providing convenient access to personal items within the bag. It is a further object and feature of the present invention to provide such a system having a secondary containment portion inside of a primary containment portion.

It is a further object and feature of the present invention to provide such a system that is retractable when attached to the leg of a user. It is a further object and feature of the present invention to provide such a system capable of displaying advertiser indicia. It is a further object and feature of the present invention to provide such a system capable of displaying association indicia. It is a further object and feature of the present invention to provide a system having two zipper tabs or more.

It is a further object and feature of the present invention to provide such a system capable of substantially protecting personable items when traveling. It is a further object and feature of the present invention to provide such a system capable of providing thermal and fluid-resistant protection to contained items. A further primary object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides a method of manufacturing a bag, such bag comprising at least one three-dimensional representation of at least one item necessary to at least one sports contest, such method comprising the steps of: holding at least one three-dimensional representation of at least one item necessary to at least one sports contest; cutting, while being held, such at least one three-dimensional representation of at least one item necessary to at least one sports contest; and creating at least one bag from such cut at least one three-dimensional representation of at least one item necessary to at least one sports contest. Moreover, it provides such a method wherein the at least one three-dimensional representation of at least one item necessary to at least one sports contest comprises essentially about one-half of a three-dimensional representation of at least one item necessary to at least one sports contest, so as to provide two of the essentially about one-half of a three-dimensional representation of at least one item necessary to at least one sports contest for every whole three-dimensional representation of an item necessary to a sports contest.

In accordance with another preferred embodiment hereof, this invention provides a product manufactured according to the above method, such product comprising at least one bag structured and arranged to bag at least one containable item; wherein such at least one bag comprises at least one front portion, at least one back portion, at least one primary interior portion, at least one primary exterior portion, and at least one accessor structured and arranged to provide accessibility to such at least one primary interior portion of such at least one bag; wherein such at least one front portion comprises at least one portion of at least one three-dimensional representation of at least one item necessary to at least one sports contest; wherein such at least one back portion is structured and arranged to enclose such at least one front portion; and wherein such at least one bag comprises at least one form maintainer structured and arranged to maintain at least one form of such at least one bag. Additionally, it provides such a product, wherein such at least one form maintainer comprises at least one connector structured and arranged to connect such at least one bag to at least one user, at least one distributor structured and arranged to distribute tension uniformly along at least one edge of such at least one bag, at least one reinforcer structured and arranged to reinforce the at least one form of such at least one bag, and at least one protector structured and arranged to protect the at least one containable item; wherein such at least one connector comprises at least one adjuster structured and arranged to provide adjustability of position of such at least one bag on the user; at least one strap structured and arranged to secure such at least one bag to the user; and at least one buckle; and at least one limiter structured and arranged to limit at least one opening ability of such at least one bag; wherein such at least one limiter comprises at least one zipper structured and arranged to limit the at least one opening ability of such at least one bag. Also, it provides such a product wherein such at least one protector comprises foam material having a thickness of about ¼ inch. In addition, it provides such a product wherein such at least one bag consists essentially of about one whole at least one three-dimensional representation of at least one item necessary to at least one sports contest. And, it provides such a product wherein such at least one three-dimensional representation of at least one item necessary to at least one sports contest comprises essentially about one-half of at least one item resembling at least one sports ball. Further, it provides such a product wherein such at least one three-dimensional representation of at least one item necessary to at least one sports contest comprises at least one item resembling at least one sports ball. Even further, it provides such a product wherein such at least one three-dimensional representation of at least one item necessary to at least one sports contest comprises at least one item resembling at least one football. Even further, it provides such a product, wherein such at least one three-dimensional representation of at least one item necessary to at least one sports contest comprises at least one item resembling at least one basketball. Even further, it provides such a product wherein such at least one three-dimensional representation of at least one item necessary to at least one sports contest comprises at least one item resembling at least one soccer ball. Even further, it provides such a product wherein such at least one three-dimensional representation of at least one item necessary to at least one sports contest comprises at least one item resembling at least one baseball. Even further, it provides such a product wherein such at least one three-dimensional representation of at least one item necessary to at least one sports contest comprises at least one item resembling at least one tennis ball. Even further, it provides such a product wherein such at least one three-dimensional representation of at least one item necessary to at least one sports contest comprises at least one item resembling at least one volleyball. Even further, it provides such a product wherein such at least one bag comprises at least one fanny pack. Even further, it provides such a product wherein such at least one bag comprises at least one backpack. Even further, it provides such a product wherein such at least one bag comprises at least one leg pack. Even further, it provides such a product wherein such at least one bag comprises at least one tote pack. Even further, it provides such a product further comprising at least one indicia. Even further, it provides such a product wherein such at least one bag comprises at least one secondary interior portion structured and arranged to contain the at least one containable item.

In accordance with a preferred embodiment hereof, this invention provides a method comprising the steps of: providing licensing to at least one manufacturer to use at least one culturally recognizable proprietary indicia; providing manufacturing by such at least one manufacturer of at least one three-dimensional representation of at least one item necessary to at least one sports contest; and providing at least one sale of such at least one three-dimensional representation of at least one item necessary to at least one sports contest; wherein such at least one three-dimensional representation of at least one item necessary to at least one sports contest comprises at least one bag; and wherein such at least one three-dimensional representation of at least one item necessary to at least one sports contest comprises such at least one culturally recognizable proprietary indicia. Moreover, it provides such a method wherein the step of providing licensing to at least one manufacturer comprises providing at least one culturally recognizable proprietary indicia licensing agreement, wherein such at least one culturally recognizable proprietary indicia comprises at least one sports related indicia.

In accordance with another preferred embodiment hereof, this invention provides a system comprising: bag means for bagging at least one bagable item, comprising at least one front portion, at least one back portion, at least one primary interior portion, and at least one primary exterior portion; and accessor means for accessing such at least one primary interior portion of such bag means; wherein such at least one front portion comprises at least one sports item structured and arranged to represent at least one portion of at least one three-dimensional representation of at least one item necessary to at least one sports contest; wherein such at least one back portion is structured and arranged to enclose such at least one front portion; and wherein such bag means comprises form maintainer means for maintaining at least one form of such bag means.

In accordance with another preferred embodiment hereof, this invention provides a system comprising: at least one bag structured and arranged to bag at least one containable item, wherein such at least one bag comprises at least one front portion, at least one back portion, at least one primary interior portion, and at least one primary exterior portion; and at least one accessor structured and arranged to provide accessibility to such at least one interior portion of such at least one bag; wherein such at least one front portion comprises at least one portion of at least one three-dimensional representation of at least one item necessary to at least one sports contest; wherein such at least one back portion is structured and arranged to enclose such at least one front portion; and wherein such at least one bag comprises at least one form maintainer structured and arranged to maintain at least one form of such at least one bag. Additionally, it provides such a system wherein such at least one form maintainer comprises at least one connector structured and arranged to connect such at least one bag to at least one user. Also, it provides such a system wherein such at least one connector comprises at least one adjuster structured and arranged to provide adjustability of position of such at least one bag on the user. In addition, it provides such a system wherein such at least one connector comprises at least one strap structured and arranged to secure such at least one bag to the user. And, it provides such a system wherein such at least one connector comprises at least one buckle. Further, it provides such a system wherein such at least one form maintainer comprises at least one distributor structured and arranged to distribute tension uniformly along at least one edge of such at least one bag. Even further, it provides such a system wherein such at least one form maintainer comprises at least one elastic material structured and arranged to maintain the form of such at least one bag under tension. Moreover, it provides such a system wherein such at least one form maintainer comprises at least one leather structured and arranged to maintain the at least one form of such at least one bag under tension. Additionally, it provides such a system wherein such at least one form maintainer comprises at least one reinforcer structured and arranged to reinforce the at least one form of such at least one bag. Also, it provides such a system wherein such at least one form maintainer comprises at least one distributor structured and arranged to distribute tension uniformly across at least one portion of such at least one bag. In addition, it provides such a system wherein such at least one form maintainer comprises at least one protector structured and arranged to protect the at least one containable item. And, it provides such a system wherein such at least one form maintainer comprises at least one padding material. Further, it provides such a system wherein such at least one form maintainer comprises at least one foam material. Even further, it provides such a system wherein such at least one foam material is about one-quarter of an inch thick. Moreover, it provides such a system wherein such at least one bag comprises at least one limiter structured and arranged to limit at least one opening ability of such at least one bag. Additionally, it provides such a system wherein such at least one limiter comprises at least one zipper structured and arranged to limit the at least one opening ability of such at least one bag. Also, it provides such a system wherein such at least one limiter comprises at least one elastic material. In addition, it provides such a system wherein such at least one three-dimensional representation of at least one item necessary to at least one sports contest comprises essentially about one-half of at least one item resembling at least one sports ball. And, it provides such a system wherein such at least one three-dimensional representation of at least one item necessary to at least one sports contest comprises at least one item resembling at least one racing wheel. Further, it provides such a system wherein such at least one three-dimensional representation of at least one item necessary to at least one sports contest comprises at least one item resembling at least one hockey puck. Even further, it provides such a system wherein such at least one three-dimensional representation of at least one item necessary to at least one sports contest comprises at least one item resembling at least one sports ball. Moreover, it provides such a system wherein such at least one three-dimensional representation of at least one item necessary to at least one sports contest comprises at least one item resembling at least one football. Additionally, it provides such a system, wherein such at least one three-dimensional representation of at least one item necessary to at least one sports contest comprises at least one item resembling at least one basketball. Also, it provides such a system wherein such at least one three-dimensional representation of at least one item necessary to at least one sports contest comprises at least one item resembling at least one soccer ball. In addition, it provides such a system wherein such at least one three-dimensional representation of at least one item necessary to at least one sports contest comprises at least one item resembling at least one tennis ball. And, it provides such a system wherein such at least one three-dimensional representation of at least one item necessary to at least one sports contest comprises at least one item resembling at least one baseball. Further, it provides such a system wherein such at least one three-dimensional representation of at least one item necessary to at least one sports contest comprises at least one item resembling at least one volleyball. Even further, it provides such a system wherein such at least one bag comprises at least one fanny pack. Moreover, it provides such a system wherein such at least one bag comprises at least one backpack. Additionally, it provides such a system wherein such at least one bag comprises at least one leg pack. Also, it provides such a system wherein such at least one bag comprises at least one tote pack. In addition, it provides such a system wherein such at least one bag consists essentially of about one whole at least one three-dimensional representation of at least one item necessary to at least one sports contest. And, it provides such a system further comprising at least one indicia. Further, it provides such a system further comprising at least one advertising indicia. Even further, it provides such a system further comprising at least one association indicia. Moreover, it provides such a system wherein such at least one bag comprises at least one zipper. Additionally, it provides such a system wherein such at least one zipper comprises at least one indicia. Also, it provides such a system wherein such at least one accessor comprises at least two zipper tabs. In addition, it provides such a system wherein such at least one bag comprises at least one secondary interior portion structured and arranged to contain the at least one containable item. And, it provides such a system wherein such at least one bag comprises at least one secondary exterior portion structured and arranged to contain the at least one containable item. Further, it provides such a system wherein such at least one bag comprises: at least one connector structured and arranged to connect such at least one bag to at least one user; and at least one limiter structured and arranged to limit at least one opening ability of such at least one bag; wherein such at least one connector comprises at least one adjuster structured and arranged to provide adjustability of position of such at least one bag on the at least one user; wherein such at least one connector comprises at least one strap structured and arranged to strap such at least one bag to the at least one user; wherein such at least one connector is structured and arranged to distribute tension uniformly along at least one edge of such at least one bag; wherein such at least one connector comprises at least one buckle; wherein such at least one form maintainer comprises at least one leather structured and arranged to maintain at least one form of such at least one bag under tension; wherein such at least one form maintainer comprises at least one foam material; wherein such at least one foam material is about one-quarter of an inch thick; wherein such at least one bag comprises at least one indicia; wherein such at least one bag comprises at least two zippers; and wherein such at least one bag comprises at least one secondary interior portion structured and arranged to contain the at least one containable item.

In accordance with another preferred embodiment hereof, this invention provides a system comprising: bag means for bagging at least one bagable item, comprising at least one front portion, at least one back portion, at least one primary interior portion, and at least one primary exterior portion; and accessor means for accessing such interior portion means of such bag means; wherein such at least one front portion comprises sports item means for representing at least one portion of at least one three-dimensional representation of at least one item necessary to at least one sports contest; wherein such at least one back portion is structured and arranged to enclose such at least one front portion; and wherein such bag means comprises reinforcer means for reinforcing at least one form of such bag means.

In accordance with another preferred embodiment hereof, this invention provides a system comprising: at least one bag structured and arranged to bag at least one containable item, wherein such at least one bag comprises at least one front portion, at least one back portion, at least one primary interior portion, and at least one primary exterior portion; and at least one accessor structured and arranged to provide accessibility to such at least one interior portion of such at least one bag; wherein such at least one front portion comprises at least one portion of at least one three-dimensional representation of at least one item necessary to at least one sports contest; wherein such at least one back portion is structured and arranged to enclose such at least one front portion; and wherein such at least one bag comprises at least one reinforcer structured and arranged to reinforce at least one form of such at least one bag.

In accordance with another preferred embodiment hereof, this invention provides a system comprising: bag means for bagging at least one bagable item, comprising at least one front portion, at least one back portion, at least one primary interior portion, and at least one primary exterior portion; and accessor means for accessing such interior portion means of such bag means; wherein such at least one front portion comprises sports item means for representing at least one portion of at least one three-dimensional representation of at least one item necessary to at least one sports contest; wherein such at least one back portion is structured and arranged to enclose such at least one front portion; and wherein such bag means comprises distributor means for distributing at least one force uniformly across at least one portion of such bag means.

In accordance with another preferred embodiment hereof, this invention provides a system comprising: at least one bag structured and arranged to bag at least one containable item, wherein such at least one bag comprises at least one front portion, at least one back portion, at least one primary interior portion, and at least one primary exterior portion; and at least one accessor structured and arranged to provide accessibility to such at least one interior portion of such at least one bag; wherein such at least one front portion comprises at least one portion of at least one three-dimensional representation of at least one item necessary to at least one sports contest; wherein such at least one back portion is structured and arranged to enclose such at least one front portion; and wherein such at least one bag comprises at least one distributor structured and arranged to distribute at least one force across at least one portion of such at least one bag.

In accordance with another preferred embodiment hereof, this invention provides a system comprising: bag means for bagging at least one bagable item, comprising at least one front portion, at least one back portion, at least one primary interior portion, and at least one primary exterior portion; and accessor means for accessing such interior portion means of such bag means; wherein such at least one front portion comprises sports item means for representing at least one portion of at least one three-dimensional representation of at least one item necessary to at least one sports contest; wherein such at least one back portion is structured and arranged to enclose such at least one front portion; and wherein such bag means comprises protector means for protecting the at least one containable item.

In accordance with another preferred embodiment hereof, this invention provides a system comprising: at least one bag structured and arranged to bag at least one containable item, wherein such at least one bag comprises at least one front portion, at least one back portion, at least one primary interior portion, and at least one primary exterior portion; and at least one accessor structured and arranged to provide accessibility to such at least one interior portion of such at least one bag; wherein such at least one front portion comprises at least one portion of at least one three-dimensional representation of at least one item necessary to at least one sports contest; wherein such at least one back portion is structured and arranged to enclose such at least one front portion; and wherein such at least one bag comprises at least one protector structured and arranged to protect the at least one containable item.

In accordance with another preferred embodiment hereof, this invention provides a system comprising: bag means for bagging at least one bagable item, comprising at least one front portion, at least one back portion, at least one primary interior portion, and at least one primary exterior portion; and accessor means for accessing such interior portion means of such bag means; wherein such at least one front portion comprises sports item means for representing at least one portion of at least one three-dimensional representation of at least one item necessary to at least one sports contest; wherein such at least one back portion is structured and arranged to enclose such at least one front portion; and wherein such bag means comprises limiter means for limiting at least one opening ability of such bag means.

In accordance with another preferred embodiment hereof, this invention provides a system comprising: at least one bag structured and arranged to bag at least one containable item, wherein such at least one bag comprises at least one front portion, at least one back portion, at least one primary interior portion, and at least one primary exterior portion; and at least one accessor structured and arranged to provide accessibility to such at least one interior portion of such at least one bag; wherein such at least one front portion comprises at least one portion of at least one three-dimensional representation of at least one item necessary to at least one sports contest; wherein such at least one back portion is structured and arranged to enclose such at least one front portion; and wherein such at least one bag comprises at least one limiter structured and arranged to limit at least one opening ability of such at least one bag.

In accordance with another preferred embodiment hereof, this invention provides a system comprising: bag means for bagging at least one bagable item, comprising at least one front portion, at least one back portion, at least one primary interior portion, and at least one primary exterior portion; and accessor means for accessing such interior portion means of such bag means; wherein such at least one front portion comprises sports item means for representing at least one portion of at least one three-dimensional representation of at least one item necessary to at least one sports contest; wherein such at least one back portion is structured and arranged to enclose such at least one front portion; and wherein such bag means comprises secondary interior portion means for providing at least one secondary interior portion of such bag means.

In accordance with another preferred embodiment hereof, this invention provides a system comprising: at least one bag structured and arranged to bag at least one containable item, wherein such at least one bag comprises at least one front portion, at least one back portion, at least one primary interior portion, and at least one primary exterior portion; and at least one accessor structured and arranged to provide accessibility to such at least one interior portion of such at least one bag; wherein such at least one front portion comprises at least one portion of at least one three-dimensional representation of at least one item necessary to at least one sports contest; wherein such at least one back portion is structured and arranged to enclose such at least one front portion; and wherein such at least one bag comprises at least one secondary interior portion structured and arranged to contain the at least one containable item.

In accordance with another preferred embodiment hereof, this invention provides a system comprising: holder means for holding at least one three-dimensional representation of at least one item necessary to at least one sports contest; and cutter means for cutting, while being held by such holder means, the at least one three-dimensional representation of at least one item necessary to at least one sports contest.

In accordance with another preferred embodiment hereof, this invention provides a system comprising: at least one holder structured and arranged to hold at least one three-dimensional representation of at least one item necessary to at least one sports contest; and at least one cutter structured and arranged to cut, while being held by such at least one holder, the at least one three-dimensional representation of at least one item necessary to at least one sports contest. Even further, it provides such a system wherein the at least one three-dimensional representation of at least one item necessary to at least one sports contest comprises essentially about one-half of a three-dimensional representation of at least one item necessary to at least one sports contest, so as to provide two of the essentially about one-half of a three-dimensional representation of at least one item necessary to at least one sports contest for every whole three-dimensional representation of an item necessary to a sports contest. Even further, it provides such a system wherein the at least one three-dimensional representation of at least one item necessary to at least one sports contest comprises at least one sports ball. In accordance with another preferred embodiment hereof, this invention provides a method comprising the steps of: holding at least one three-dimensional representation of at least one item necessary to at least one sports contest; and cutting, while being held, such at least one three-dimensional representation of at least one item necessary to at least one sports contest. Even further, it provides such a method further comprising creating at least one bag utilizing such at least one three-dimensional representation of at least one item necessary to at least one sports contest. Even further, it provides such a method wherein such at least one three-dimensional representation of at least one item necessary to at least one sports contest comprises at least one sports ball. Still further, it provides each and every novel feature, element, combination, step and/or method disclosed or suggested by this provisional patent application.

### BRIEF DESCRIPTION OF THE DRAWINGS

FIG. 1A is a diagrammatic view of a sports ball bag method according to a preferred embodiment of the present invention.

FIG. 1B is a blown-up cross-section of a sports ball bag system, a racing wheel fanny pack, according to a preferred embodiment of the present invention.

FIG. 1C is a cut-away view of the racing wheel fanny pack of FIG. 1B.

FIG. 1D is a back view of the racing wheel fanny pack of FIG. 1B.

FIG. 1E is a top view of the racing wheel fanny pack of FIG. 1B.

FIG. 1F is a side view of the racing wheel fanny pack of FIG. 1B.

FIG. 1G is a perspective view of the racing wheel fanny pack of FIG. 1B.

FIG. 1H is a front view of the racing wheel fanny pack of FIG. 1B.

FIG. 2A is a perspective view of the sports ball bag system, a soccer ball fanny pack, according to a preferred embodiment of the present invention.

FIG. 2B is a front view of the soccer ball fanny pack of FIG. 2A.

FIG. 3A is a perspective view of a sports ball bag system, a baseball fanny pack, according to a preferred embodiment of the present invention.

FIG. 3B is a front view of the baseball fanny pack of FIG. 3A.

FIG. 4A is a perspective view of a sports ball bag system, a volleyball fanny pack, according to a preferred embodiment of the present invention.

FIG. 4B is a front view of the volleyball fanny pack of FIG. 4A.

FIG. 5A is a perspective view of a sports ball bag system, a football fanny pack, according to a preferred embodiment of the present invention.

FIG. 5B is a front view of the football fanny pack of FIG. 5A.

FIG. 5C is a top view of the football fanny pack of FIG. 5A.

FIG. 5D is a side view of the football fanny pack of FIG. 5A.

FIG. 6A is a blown-up cross-section view of a football tote bag, having detachable handles, of the sports ball bag system according to a preferred embodiment of the present invention.

FIG. 6B is a cut-away view of the football tote bag of FIG. 6A.

FIG. 6C is a back view of the football tote bag of FIG. 6A.

FIG. 6D is a top view of the football tote bag of FIG. 6A.

FIG. 6E is a side view of the football tote bag of FIG. 6A.

FIG. 6F is a perspective view of the football tote bag of FIG. 6A.

FIG. 6G is a front view of the football tote bag of FIG. 6A.

FIG. 7A is a blown-up cross-section view of a sports ball bag system, a football leg pack, according to a preferred embodiment of the present invention.

FIG. 7B is a cut-away view of the football leg pack of FIG. 7A.

FIG. 7C is a back view of the football leg pack of FIG. 7A.

FIG. 7D is a top view of the football leg pack of FIG. 7A.

FIG. 7E is a perspective view of the football leg pack of FIG. 7A.

FIG. 7F is a front view of the football leg pack of FIG. 7A.

FIG. 7G is a side view of the football leg pack of FIG. 7A.

FIG. 8A is a cross-section view of a sports ball bag system, a football backpack, according to a preferred embodiment of the present invention.

FIG. 8B is a cut-away view of the football backpack of FIG. 8A.

FIG. 8C is a back view of the football backpack of FIG. 8A.

FIG. 8D is a top view of the football backpack of FIG. 8A.

FIG. 8E is a side view of the football backpack of FIG. 8A.

FIG. 8F is a perspective view of the football backpack of FIG. 8A.

FIG. 8G is a front view of the football backpack of FIG. 8A.

FIG. 9 is a perspective view of a holder and cutter according to a preferred embodiment of the present invention.

FIG. 10 is a diagrammatic view of a manufacturing method according to a preferred embodiment of the present invention.

### DETAILED DESCRIPTION OF THE BEST MODES AND PREFERRED EMBODIMENTS OF THE INVENTION

Sports ball bag system 1000 preferably comprises method 1001, fanny pack system 1100, backpack system 1200, leg pack system 1300, tote pack system 1400, manufacturing system 1500, and method 1002.

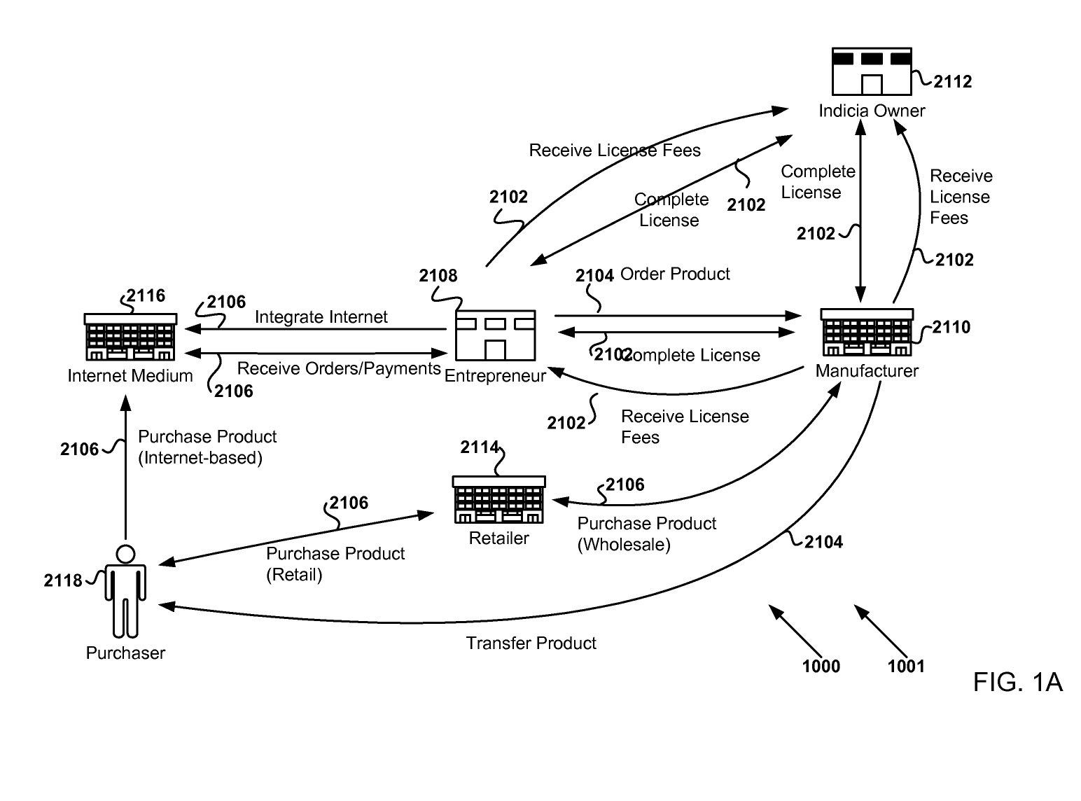

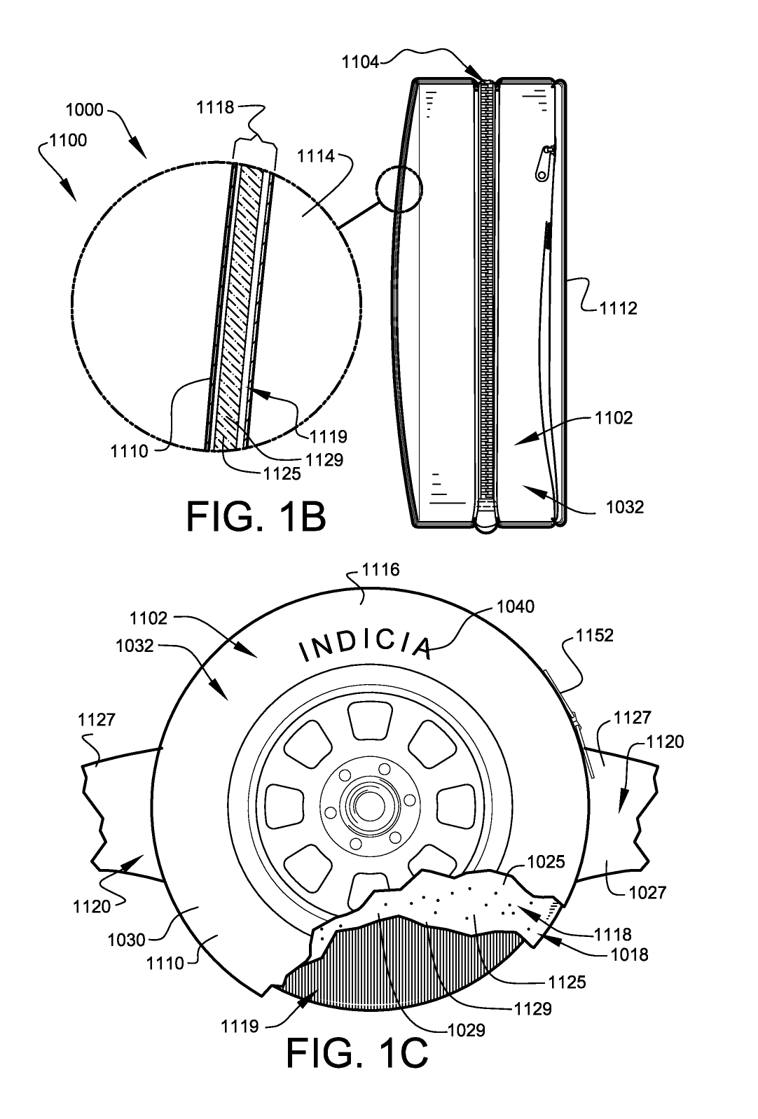

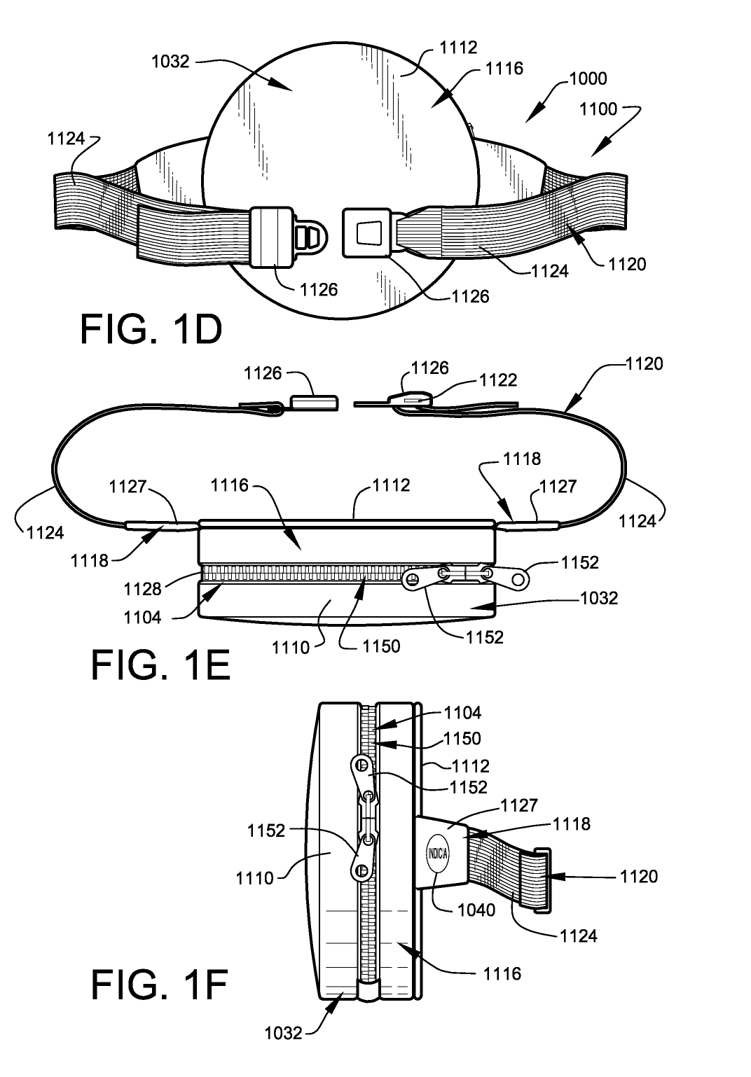

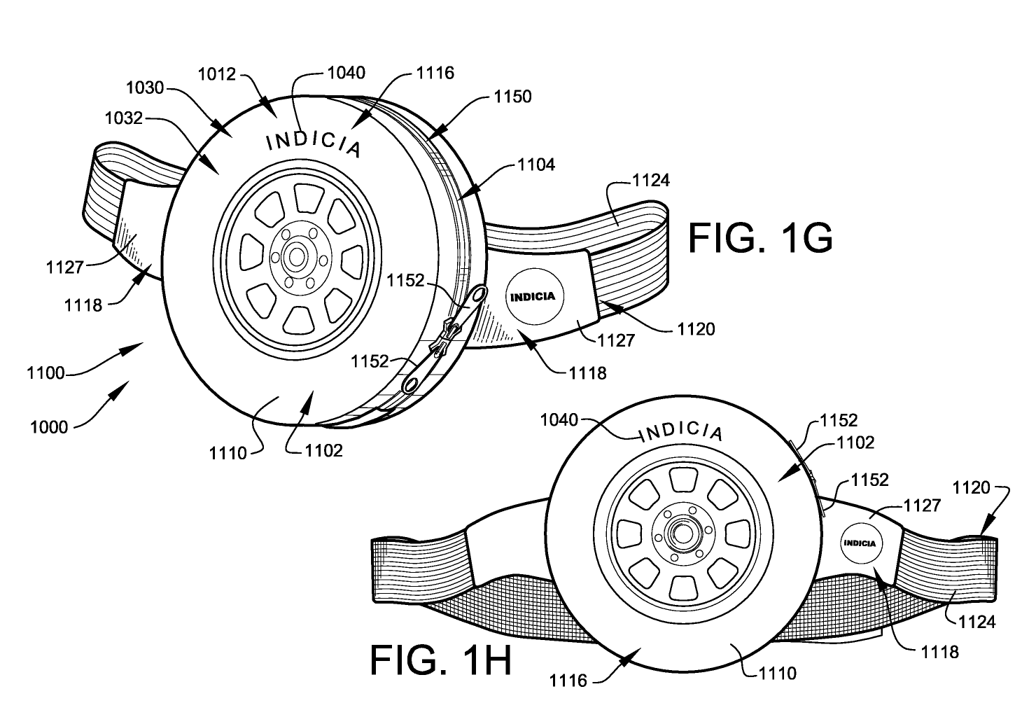

FIG. 1A is a diagrammatic view of a sports ball bag method according to a preferred embodiment of the present invention. AS shown in FIG. 1A, sports ball bag system 1000 preferably comprises method 1001. Preferably, method 1001 comprises the steps of: providing licensing to at least one manufacturer to use at least one culturally recognizable proprietary indicia (step 2102); providing manufacturing by the at least one manufacturer of at least one three-dimensional representation of at least one item necessary to at least one sports contest (step 2104); and providing at least one sale of the at least one three-dimensional representation of at least one item necessary to at least one sports contest (step 2106), as shown.

Preferably, step 2102 comprises completing licensing between Entrepreneur 2108 and Indicia Owner 2112, preferably proprietary indicia licensing, preferably culturally recognizable proprietary indicia licensing. Preferably, step 2102 comprises completing licensing between Entrepreneur 2108 and Manufacturer 2110, preferably manufacturing licensing. Preferably, step 2102 comprises completing licensing between Indicia Owner 2112 and Manufacturer 2110, preferably proprietary indicia licensing, preferably culturally recognizable proprietary indicia licensing. Preferably, the at least one three-dimensional representation of at least one item necessary to at least one sports contest 1030 comprises at least one bag structured and arranged to bag or contain items. Preferably, the at least one three-dimensional representation of at least one item necessary to at least one sports contest 1030 comprises licensed, preferably by the above methods, culturally recognizable proprietary indicia. Preferably, step 2102 comprises Licensors (preferably Indicia Owner 2112, as shown) receiving licensing fees from Licensees (preferably Entrepeneur 2108, as shown).

Preferably, step 2104 comprises the ordering of product from Manufacturer 2110, preferably the ordering of product by Entrepreneur 2108 from Manufacturer 2110. Preferably, step 2104 comprises Manufacturer 2110 providing for product transfer, preferably product transfer from Manufacturer 2110 directly to a Purchaser 2118.

Preferably, step 2106 comprises wholesale product purchases from Manufacturer 2110, preferably purchases by a Retailer 2114 from Manufacturer 2110, with product preferably being retailed by Retailer 2114 to a Purchaser 2118. Preferably, step 2106 comprises the use of an Internet Medium 2116 by Entrepreneur 2108, preferably to sell product by receiving orders and payments by way of the Internet Medium 2116, preferably for selling product directly to a Purchaser 2118.

Preferably, the at least one three-dimensional representation of at least one item necessary to at least one sports contest 1030 comprises culturally recognizable proprietary indicia, such as sports indicia, governing association indicia, advertiser indicia, manufacturer indicia, and/or other proprietary indicia. Upon reading the teachings of this specification, those of ordinary skill in the art will now understand that, under appropriate circumstances, considering such issues as marketing, technology, cost, popular culture, etc., other culturally recognizable proprietary indicia, such as, for example, names, faces, companies, logos, other proprietary indicia, etc., may suffice.

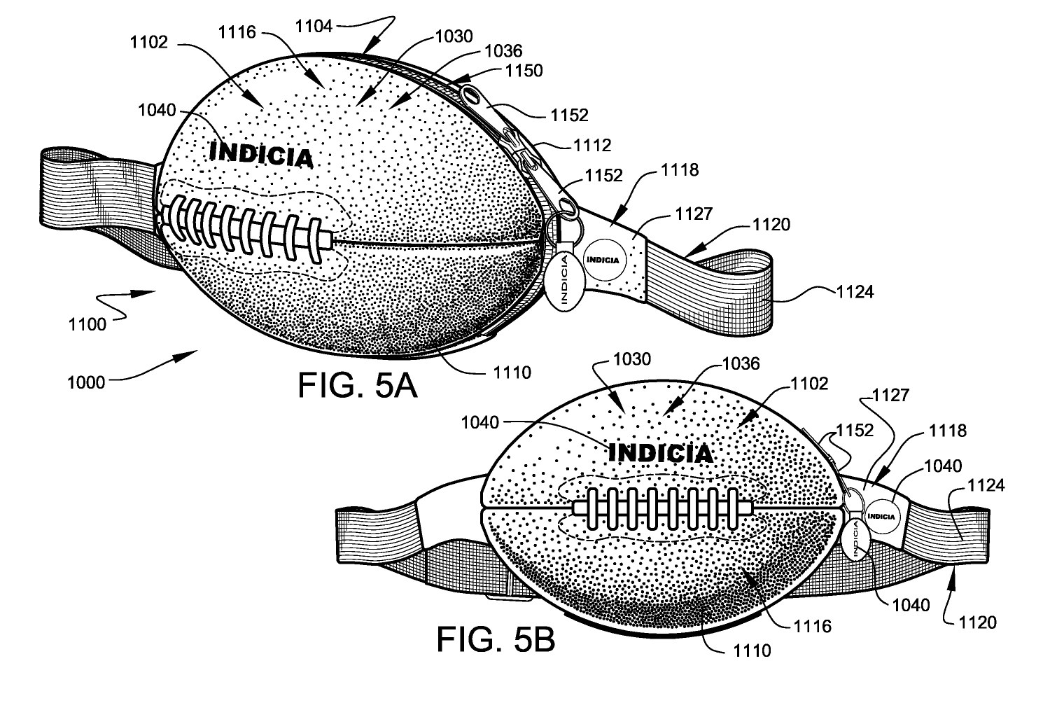

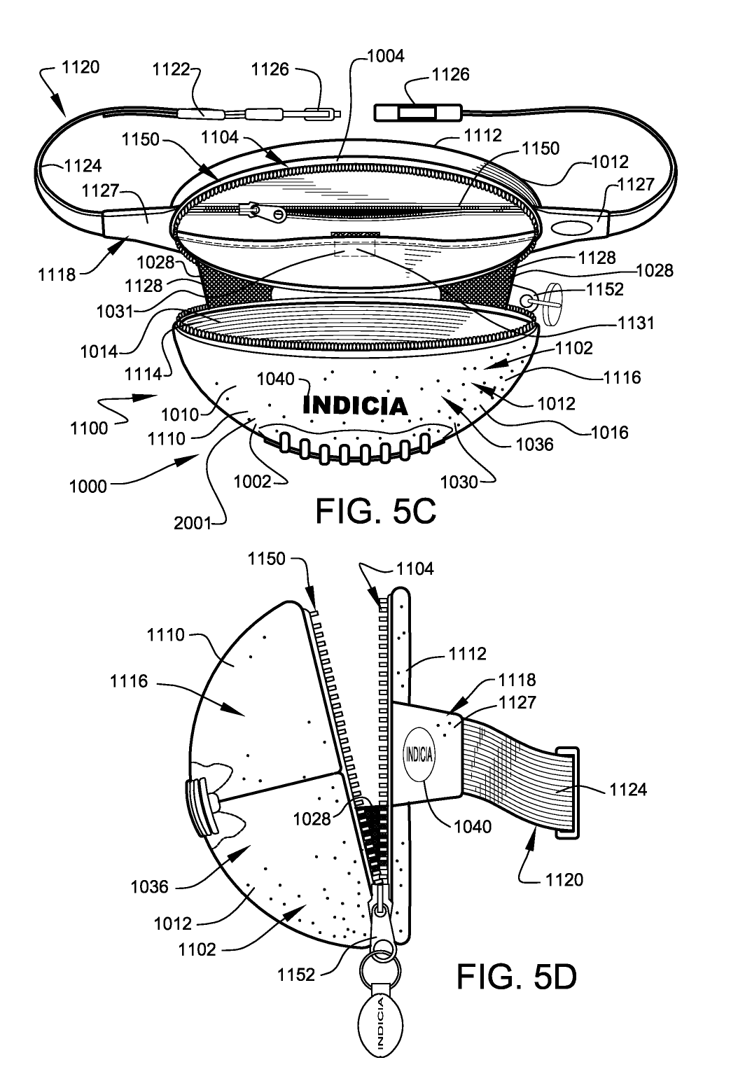

As shown in FIG. 5C, system 1000 preferably comprises bag 1002 and accessor 1004. Bag 1002 preferably comprises front portion 1010, back portion 1012, primary interior portion 1014, and primary exterior portion 1016. In addition, as shown in FIG. 5C, system 1000 preferably comprises secondary interior portion 1031. Furthermore, as shown is FIG. 5C, system 1000 preferably comprises limiter 1028.

As shown in FIG. 1C, system 1000 preferably comprises form maintainer 1018. Form maintainer 1018 preferably comprises reinforcer 1025. Form maintainer 1018 preferably comprises distributor 1027. Form maintainer 1018 preferably comprises protector 1029. System 1000 preferably comprises at least a portion of a three-dimensional representation of an item necessary to a sports contest 1030 (herein referred to as sports item 1030). In one preferred embodiment, sports item 1030 preferably comprises essentially about one-half of an item resembling a sports ball.

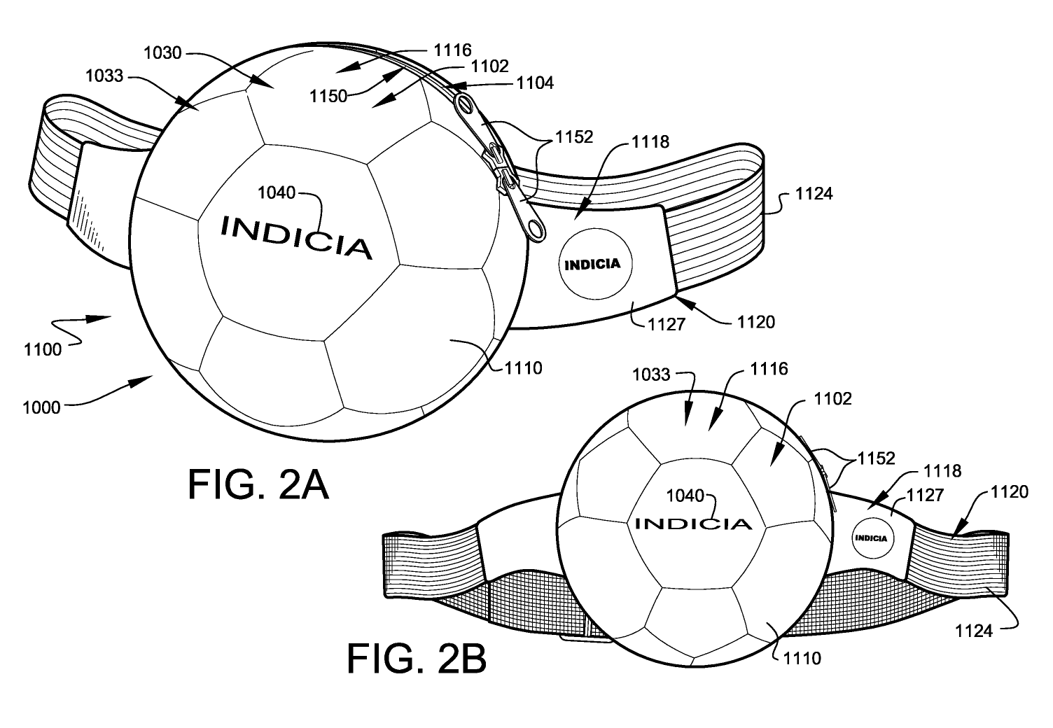

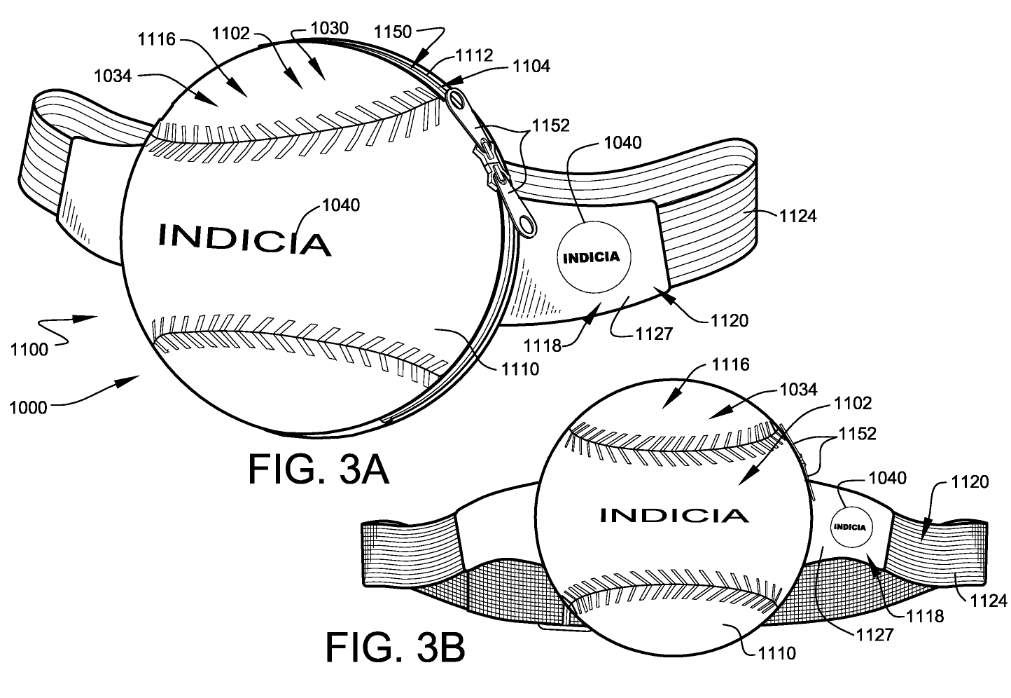

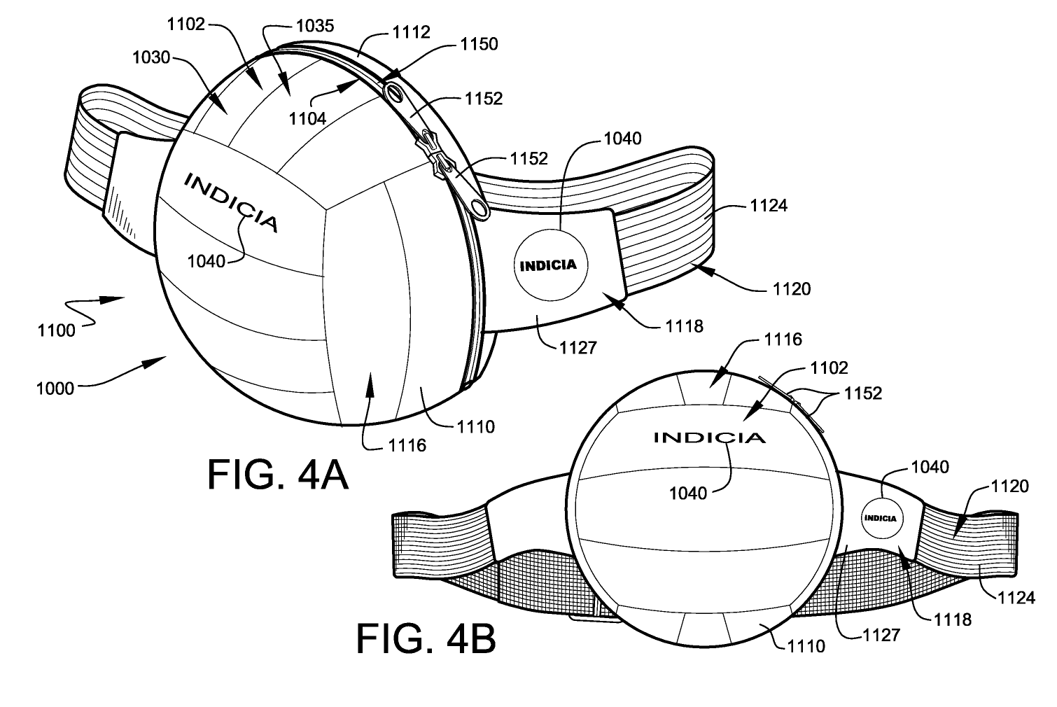

Sports item 1030 preferably comprises racing wheel 1032 (as shown in FIGS. 1B through 1H), soccer ball 1033 (as shown in FIGS. 2A and 2B), baseball 1034 (as shown in FIGS. 3A and 3B), volleyball 1035 (as shown in FIGS. 4A and 4B), and football 1036 (as shown in FIGS. 5A through 5D). Upon reading the teachings of this specification, those of ordinary skill in the art will now understand that, under appropriate circumstances, considering such issues as market demand, technology, cost, etc., other sports items 1030, such as, for example, pucks, balls, other projectiles, sticks, bats, gloves, tees, other instruments, helmets, other protective apparatus, bases, other field marking apparatus, etc., may suffice.

System 1000 preferably comprises the specific details of the sports item 1030 represented, such as size, shape, material, color, texture, seam arrangement, symmetry, common indicia, etc. Preferably, the portion represented, projecting away from the user, is the most detailed portion of the sports item 1030 represented, as shown in FIG. 5A.

For example, a sports item 1030, such as a football, would preferably comprise a portion of a football, preferably with a size relative to the utility and size of the user, preferably one-half of a football, preferably shaped substantially identical to a football, preferably made of a material which looks like leather (or more preferably leather), preferably brown in color, preferably with a dimpled texture (as shown in FIG. 5A), preferably having about eight white laces in parallel (as shown in FIG. 5A), where bag 1012 is preferably horizontally and vertically symmetric to the user (as shown in FIG. 5A), preferably with football related indicia (such as “NFL”), and preferably with a manufacturer emblem (such as Wilson™).

Preferably, sports item 1030 comprises an appearance similar in pattern and appearance to actual items necessary to a sports contest. Upon reading the teachings of this specification, those with ordinary skill in the art will now understand that, under appropriate circumstances, considering issues such as manufacturing, cost, materials, etc., other arrangements, such as fewer seams, extra seams, a vertical representation rather than the horizontal representation shown in FIG. 1B (capable of holding beverages), non-brown colors, non-dimpled, non-symmetric, abnormally sized, abnormally shaped, alternative indicia, etc., may suffice. Additionally, the portion of the sports item represented need not be about half its actual size. For example, utilizing almost the entire portion of a hockey puck, basketball hoop, or racing wheel, or some other non-half portion of the sports related item, may suffice. Furthermore, various bag 1012 sizes, such as child size, junior, adult, extra large, non-life size, miniature, etc., may suffice. In addition, alternate materials, such as rubber, plastic, felt, non-leather, suede, metal, non-ball materials, Velcro™, other textures, etc., may suffice. Also, alternative color configurations, such as bright colors, advertiser-specific colors, ‘zebra’ stripes, theme-specific colors, non-typical ball colors, glittered, iridescent, etc., may suffice.

System 1000 preferably comprises indicia 1040. Indicia 1040 preferably comprise sports related indicia. Indicia 1040 preferably comprise advertising indicia. Indicia 1040 preferably comprise association indicia.

Racing wheel 1032 preferably comprises indicia 1040. Racing wheel 1032 preferably comprises professional racing indicia 1040. Upon reading the teachings of this specification, those of ordinary skill in the art will now understand that, under appropriate circumstances, considering issues such as marketing, advertising, cost, team and player popularity, business benefits, technology, etc., other non-professional racing indicia, such as, for example, manufacturers, slogans, advertisers, racers, and racing crews, such as Formula One, Monster Truck Racing Association (MTRA), National Hotrod Racing Association (NHRA), American Motorcycle Racing Association (AMRA), the phrase “c′”, Goodyear, Ford, Chevrolet, Toyota, Dale Earnhardt, Jeff Gordon, Rusty Wallace, Pennzoil, Penske, Budweiser, Molson, 7-Up, etc., may suffice.

Soccer ball 1033 preferably comprises indicia 1040. Soccer ball 1033 preferably comprises professional soccer indicia 1040. Upon reading the teachings of this specification, those of ordinary skill in the art will now understand that, under appropriate circumstances, considering issues such as marketing, advertising, cost, team and player popularity, business benefits, etc., other non-professional soccer indicia, such as, for example, associations, manufacturers, slogans, advertisers, players, and teams, such as Major League Soccer (MLS), Union of European Football Associations (UEFA), National Collegiate Athletics Association (NCAA), the phrase “GOOOOOOAAAAAAL . . . ”, Umbro, Adidas, Mizuno, Nike, Coke, Gatorade, IBM, Renaldo, David Beckham, Mia Hamm, Team USA Soccer, San Jose Earthquakes, North Carolina Tarheels, etc., may suffice.

Baseball 1034 preferably comprises indicia 1040. Baseball 1034 preferably comprises professional baseball indicia 1040. Upon reading the teachings of this specification, those of ordinary skill in the art will now understand that, under appropriate circumstances, considering issues such as marketing, advertising, cost, team and player popularity, business benefits, etc., other non-professional baseball and softball indicia, such as, for example, associations, manufacturers, slogans, advertisers, players, and teams, such as the National Collegiate Athletic Association (NCAA), International Baseball Association (IBA), National Softball Association (NSA), Little League Baseball, the phrase “Holy Cow”, Mizuno, Nike, Reebok, Rawlings, Randy Johnson, Barry Bonds, Lisa Fernandez, New York Yankees, Rice Owls, Team USA, etc., may suffice.

Volleyball 1035 preferably comprises indicia 1040. Volleyball 1035 preferably comprises professional volleyball indicia 1040. Upon reading the teachings of this specification, persons of ordinary skill in the art will now understand that, under appropriate circumstances, considering issues such as marketing, advertising, cost, team and player popularity, business benefits, etc., other non-professional volleyball indicia, such as, for example, associations, manufacturers, slogans, advertisers, players, and teams, such as the National Collegiate Athletic Association (NCAA), USA Volleyball, Pro Beach Volleyball, Tachikara, Baden, Molten, Mazda, Southwest Airlines, Karch Kiraly, Misty May, UCLA Bruins, Team USA, etc., may suffice.

Football 1036 preferably comprises indicia 1040. Football 1036 preferably comprises professional football indicia 1040. Upon reading the teachings of this specification, those of ordinary skill in the art will now understand that, under appropriate circumstances, considering issues such as marketing, advertising, cost, team and player popularity, business benefits, etc., other non-professional football indicia, such as, for example, associations, manufacturers, slogans, advertisers, players, and teams, such as Canadian Football League (CFL), Arena Football League (AFL), National Collegiate Athletics Association (NCAA), the phrase “raise the roof”, Wilson, Nike, Reebok, Coke, EA Sports, Outback Steakhouse, Tostitos, Nokia, FedEx, Marshall Faulk, Michael Vick, Eddie George, Oakland Raiders, Ohio State Buckeyes, Arizona Rattlers, etc., may suffice.

Preferably, sports item 1030 sports contest related sports items comprising sports contests other than racing, baseball, volleyball, and football. Upon reading the teachings of this specification, those with ordinary skill in the art will now understand that, under appropriate circumstances, considering issues such as popularity, cost, market demand, etc., other sports contests, such as golf, track & field, ping pong, swimming, shooting, chess, hockey, spelling bees, game shows, reality shows, other competitions, etc., may suffice.

Sports ball bag system 1000 preferably comprises fanny pack system 1100. System 1100 preferably comprises bag 1102 and accessor 1104. Bag 1102 preferably comprises front portion 1110, back portion 1112, primary interior portion 1114, and primary exterior portion 1116 (embodying herein, bag means for containing the at least one containable item). Bag 1102 preferably comprises fanny pack 2001, as shown in FIGS. 5A through 5D. Upon reading the teachings of this specification, those of ordinary skill in the art will now understand that, under appropriate circumstances, considering such issues as utility, fashion, technology, cost, etc., other packs and orientations, such as, for example, front packs, carriers, holders, other packs, clothing, packs on other parts of the body, etc., may suffice.

Front portion 1110 preferably comprises at least one portion of sports item 1030 (embodying herein, front portion means for providing at least one front portion of said bag means). Preferably, system 1000 comprises the specific details of the sports related item represented, such as size, shape, material, color, texture, seam arrangement, symmetry, common indicia, etc. Preferably, the portion represented, projecting away from the user, is the most detailed portion of the sports item represented, as shown.

For example, a football-related sports item 1030, such as a football, would preferably comprise a portion of an actual football, or replica of a football, preferably of various sizes, preferably dependent on the size of the user in light of usability, preferably shaped substantially identical to a football, preferably made of a material which looks like leather, preferably brown in color, preferably with a dimpled texture, preferably having about eight white laces in parallel, where bag 1102 is preferably horizontally and vertically symmetric to the user, with football related indicia (such as “NFL”), and a manufacturer emblem (such as Wilson™).

Back portion 1112 preferably encloses front portion 1110, resulting in bag 1102 (embodying herein, back portion means for providing at least one back portion of said bag means). Preferably, back portion 1112 is substantially flat, as shown, contoured to provide comfort and ease of use. A substantially flat back portion 1112 provides contour and comfort against the user. Preferably, back portion 1112 comprises an inexpensive, non-aggravating material. Preferably, back portion 1112 provides for comfortable wearability by the user.

System 1000 preferably comprises primary interior portion 1114, which is capable of holding containable items (embodying herein, primary interior portion means for providing at least one interior portion of said bag means). Interior portion 1114 preferably comprises liner 1119, which lines the interior of bag 1102. Liner 1119 preferably comprises a fluid blocker, preferably creating a waterproof bag 1102, which prevents saturation of containable items contained within bag 1102. Liner 1119 preferably comprises a thermal blocker, preferably creating a thermally consistent interior portion 1114, maintaining a consistent temperature for containable items. Liner 1119 preferably comprises vinyl.

System 1000 preferably comprises primary exterior portion 1116 (embodying herein, primary exterior portion means for providing at least one exterior portion of said bag means). System 1000 preferably comprises secondary interior portion 1131, which is capable of holding containable items (embodying herein, secondary interior portion means for providing at least one secondary interior portion of said bag means). Secondary interior portion 1131 preferably comprises a pocket with zipper 1150. Secondary interior portion 1131 preferably comprises a pocket having a closeable hook and loop fastener system (also commonly referred to as Velcro™), as shown. System 1000 preferably comprises a pocket with a zipper 1150 and a Velcro™ pocket, as shown in FIG. 5C. System 1000 may also comprise secondary exterior portion, which may also contain containable items. Upon reading the teachings of this specification, those with ordinary skill in the art will now understand that, under appropriate circumstances, considering issues such as market demand, manufacturing, materials, cost, etc., other secondary interior portion 1131 arrangements, such as, for example, pockets, folders, snaps, buckles, tension brackets, Velcro™, multiple openings, etc., may suffice.

Accessor 1104 is preferably located between front portion 1110 and back portion 1112, as shown (embodying herein, accessor means for accessing said interior portion means of said bag means). Accessor 1104 preferably comprises zipper 1150, as shown. Preferably, accessor 1104 comprises zipper tab 1152, as shown. Preferably, system 1000 comprises a zipper 1150 that extends about 50% or more around the circumference (or perimeter) of bag 1012, as shown in FIG. 5C. Upon reading the teachings of this specification, those with ordinary skill in the art will now understand that, under appropriate circumstances, considering issues such as market demand, manufacturing, materials, cost, etc., other accessor arrangements, such as, for example, snaps, buckles, tension brackets, Velcro™, other locations for accessor 1104, zippers that extend about 50% or less around the circumference of the bag, multiple openings, etc., may suffice.

System 1000 preferably comprises form maintainer 1118 (embodying herein, form maintainer means for maintaining the form of said bag means), as shown. Form maintainer 1118 preferably comprises an actual sports item 1030, where the material of sports item 1030 sufficiently maintains the form of sports item 1030. Form maintainer 1118 preferably comprises reinforcer 1125, which reinforces the form of bag 1102, which sometimes occurs when, for example, bag 1102 is under compression (embodying herein, reinforcer means for reinforcing the form of said bag means). Reinforcer 1125 preferably comprises foam. Reinforcer 1125 preferably comprises padding. Reinforcer 1125 preferably comprises a uniform foam padding having a thickness of about ¼ inch. Form maintainer 1118 preferably comprises distributor 1127, which distributes tension uniformly across bag 1102, which sometimes occurs, for example, when bag 1102 is under tension due to forces on connector 1120 (embodying herein, distributor means for distributing force uniformly across said bag means). Distributor 1127 preferably comprises leather, preferably leather portions which attach connector 1120 to bag 1102. Distributor 1127 preferably comprises a widening portion of leather, where the portion attaching to bag 1102 is wider than the portion attaching to connector 1120, as shown. Form maintainer 1118 preferably comprises protector 1129, which protects the containable items inside bag 1102 (embodying herein, protector means for protecting the at least one containable item). Protector 1129 preferably comprises foam. Protector 1129 preferably comprises padding. Protector 1129 preferably comprises a uniform foam padding having a thickness of about ¼ inch. Upon reading the teachings of this specification, those of ordinary skill in the art will now understand that, under appropriate circumstances, considering such issues as materials, market demand, technology, cost, etc., other form maintainers, such as, for example, metal, cotton, composite, plastic, rubber, other fabrics, other materials, other reinforcers, other tension distributors, thermal blockers, fluid blockers, other compression preventers, other shapes, other elastic objects, etc., may suffice.

System 1000 preferably comprises connector 1120. Connector 1120 preferably comprises strap 1124. Connector 1120 preferably comprises buckle 1126. Connector 1120 preferably comprises elastic material. Connector 1120 preferably comprises some leather, where connector 1120 connects to bag 1102. More preferably, connector 1120 comprises a substantial amount of leather where connector 1120 connects to bag 1102, as shown. Connector 1120 preferably comprises distributor 1127, which distributes tension uniformly across bag 1102. Alternatively, bag 1102 is sufficient to function with or without a connector 1120. Upon reading the teachings of this specification, those of ordinary skill in the art will now understand that, under appropriate circumstances, considering issues such as cost, manufacturing, container detachability, etc., other connectors, such as, for example, Velcro™, hooks, stitched and non-stitched attachers, clothing articles, etc., may suffice.

System 1000 preferably comprises connector 1120. Connector 1120 preferably comprises adjuster 1122, for tightening or loosening by adjusting, preferably, the length of straps 1124. Preferably, adjuster 1122 comprises a bracket that slides along straps 1124. Upon reading the teachings of this specification, those with ordinary skill in the art will now understand that, under appropriate circumstances, considering issues such as cost, manufacturing, materials, etc., other adjusters 1122, such as, for example, pinching adjusters, spacers, straps with greater elasticity, Velcro™, hooks, other adjusters, etc., may suffice.

System 1000 preferably comprises limiter 1128 (embodying herein, limiter means for limiting the opening ability of said bag means). Limiter 1128 preferably comprises a zipper 1150 arranged so as to prevent containable items from falling out of bag 1102, as shown in FIGS. 5C and 5D. Limiter 1128 preferably comprises a zipper 1150 located across the top half of bag 1102, as shown. Limiter 1128 preferably comprises elastic material. Upon reading the teachings of this specification, those of ordinary skill in the art will now understand that, under appropriate circumstances, considering such issues as usability, market demand, technology, cost, etc., other limiter 1128 arrangements, such as, for example, elastic material connecting front portion 1110 to back portion 1112 via primary interior portion 1114, clips, Velcro™, etc., may suffice.

System 1000 preferably comprises zippers 1150. Zipper 1150 preferably comprises zipper tab 1152. Zipper 1150 preferably comprises two zipper tabs 1152 where zipper 1150 comprises accessor 1104. Zipper 1150 preferably comprises limiter 1128. Zipper 1150 preferably is structured and arranged so as to prevent containable items from falling out of bag 1102.

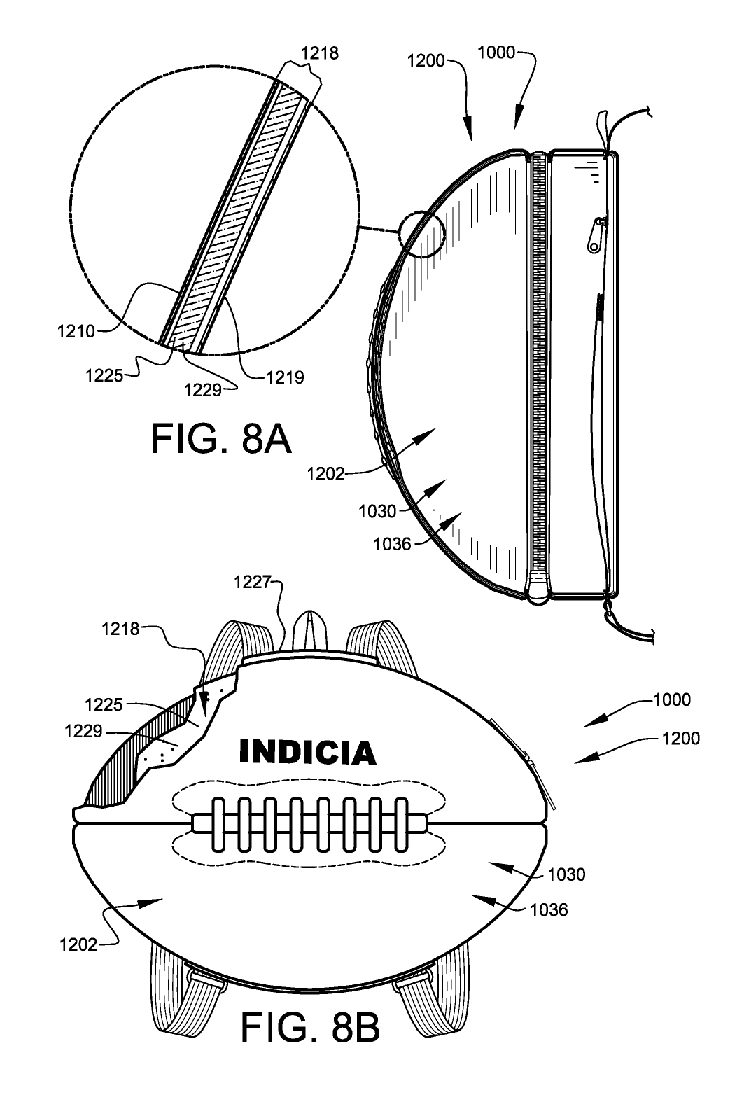

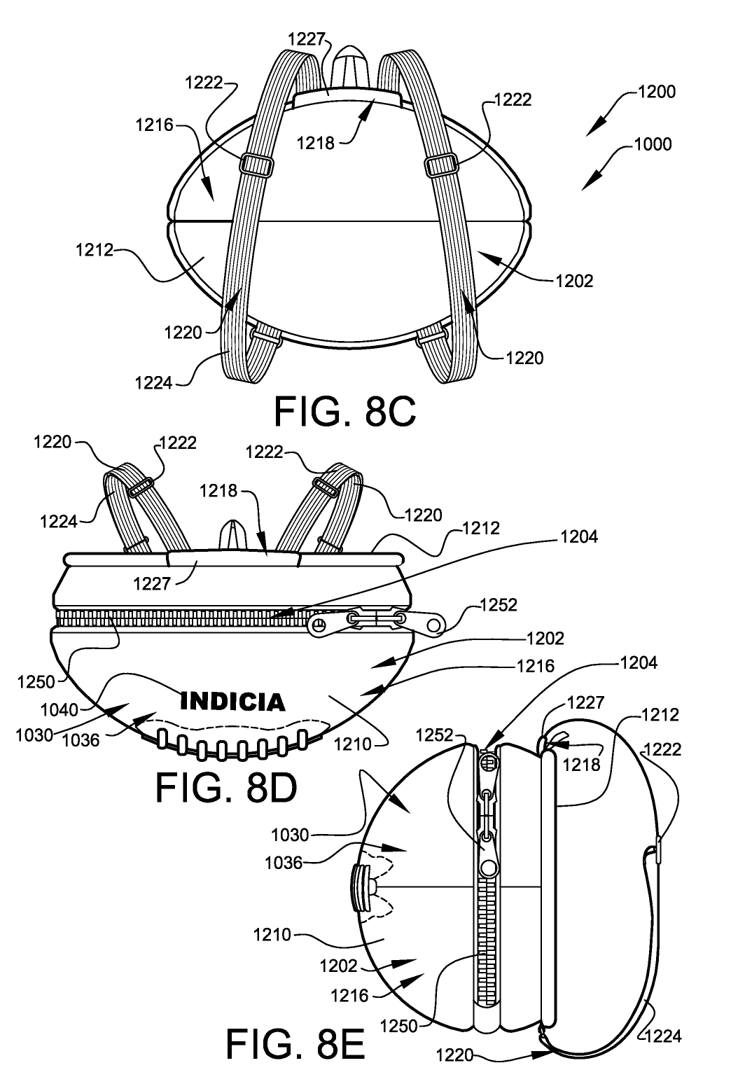

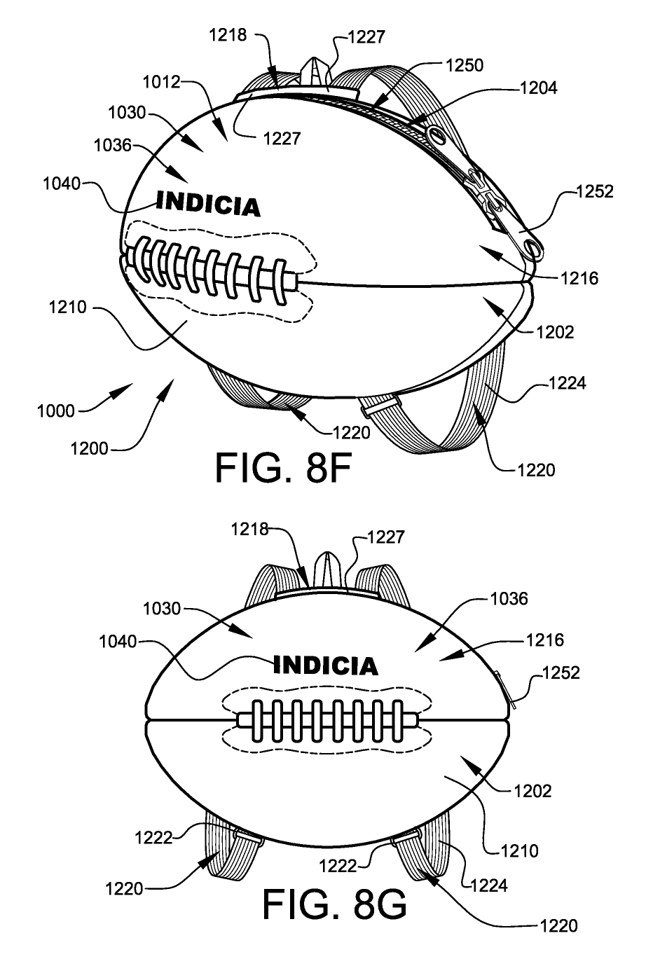

Sports ball bag system 1000 preferably comprises backpack system 1200. System 1200 preferably comprises bag 1202 and accessor 1204. Bag 1202 preferably comprises front portion 1210, back portion 1212, primary interior portion 1214, and primary exterior portion 1216 (embodying herein, bag means for containing the at least one containable item). Bag 1202 preferably comprises backpack 2004, as shown in FIGS. 8A through 8G. Upon reading the teachings of this specification, those of ordinary skill in the art will now understand that, under appropriate circumstances, considering such issues as utility, fashion, technology, cost, etc., other packs and orientations, such as, for example, front packs, carriers, holders, other packs, clothing, packs on other parts of the body, etc., may suffice.

Front portion 1210 preferably comprises at least one portion of sports item 1030 (embodying herein, front portion means for providing at least one front portion of said bag means). Preferably, system 1000 comprises the specific details of the sports related item represented, such as size, shape, material, color, texture, seam arrangement, symmetry, common indicia, etc. Preferably, the portion represented, projecting away from the user, is the most detailed portion of the sports item represented, as shown.

For example, a football-related sports item 1030, such as a football, would preferably comprise a portion of an actual football or replica of a football, preferably of various sizes, preferably dependent on the size of the user in light of usability, preferably shaped substantially identical to a football, preferably made of a material which looks like leather, preferably brown in color, preferably with a dimpled texture, preferably having about eight white laces in parallel, where bag 1202 is preferably horizontally and vertically symmetric to the user, with football related indicia (such as “NFL”), and a manufacturer emblem (such as Wilson™).

Back portion 1212 preferably encloses front portion 1210, resulting in bag 1202 (embodying herein, back portion means for providing at least one back portion of said bag means). Preferably, back portion 1212 is substantially flat, as shown, contoured to provide comfort and ease of use. A substantially flat back portion 1212 provides contour and comfort against the user. Preferably, back portion 1212 comprises an inexpensive, non-aggravating material. Preferably, back portion 1212 provides for comfortable wearability by the user.

System 1000 preferably comprises primary interior portion 1214, which is capable of holding containable items (embodying herein, primary interior portion means for providing at least one interior portion of said bag means). Interior portion 1214 preferably comprises liner 1219, which lines the interior of bag 1202. Liner 1219 preferably comprises a fluid blocker, preferably creating a waterproof bag 1202, which prevents saturation of containable items. Liner 1219 preferably comprises a thermal blocker, preferably creating a thermally consistent interior portion 1214, maintaining a consistent temperature for containable items. Liner 1219 preferably comprises vinyl.

System 1000 preferably comprises primary exterior portion 1216 (embodying herein, primary exterior portion means for providing at least one exterior portion of said bag means). System 1000 preferably comprises secondary interior portion 1231, which is capable of holding containable items (embodying herein, secondary interior portion means for providing at least one secondary interior portion of said bag means). Secondary interior portion 1231 preferably comprises a pocket with a zipper 1250. Secondary interior portion 1231 preferably comprises a Velcro™ pocket. System 1000 preferably comprises a pocket with a zipper 1250 and a Velcro™ pocket, as shown in FIG. 5C. System 1000 may also comprise secondary exterior portion, which may also contain containable items. Upon reading the teachings of this specification, those with ordinary skill in the art will now understand that, under appropriate circumstances, considering issues such as market demand, manufacturing, materials, cost, etc., other secondary interior portion 1231 arrangements, such as, for example, pockets, folders, snaps, buckles, tension brackets, Velcro™, multiple openings, etc., may suffice.

Accessor 1204 is preferably located between the front portion 1210 and the back portion 1212, as shown (embodying herein, accessor means for accessing said interior portion means of said bag means). Accessor 1204 preferably comprises zipper 1250, as shown. Preferably, accessor 1204 comprises zipper tab 1252, as shown. Preferably, system 1000 comprises a zipper 1250 that extends about 50% or more around the circumference (or perimeter) of bag 1012, as shown in FIG. 5C. Upon reading the teachings of this specification, those with ordinary skill in the art will now understand that, under appropriate circumstances, considering issues such as market demand, manufacturing, materials, cost, etc., other accessor arrangements, such as, for example, snaps, buckles, tension brackets, Velcro™, other locations for accessor 1204, zippers that extend about 50% or less around the circumference of the bag, multiple openings, etc., may suffice.

System 1000 preferably comprises form maintainer 1218 (embodying herein, form maintainer means for maintaining the form of said bag means), as shown. Form maintainer 1218 preferably comprises an actual sports item 1030, where the material sports item 1030 is made out of sufficiently maintains the form of sports item 1030. Form maintainer 1218 preferably comprises reinforcer 1225, which reinforces the form of bag 1202, which sometimes occurs when, for example, bag 1202 is under compression (embodying herein, reinforcer means for reinforcing the form of said bag means). Reinforcer 1225 preferably comprises foam. Reinforcer 1225 preferably comprises padding. Reinforcer 1225 preferably comprises a uniform foam padding having a thickness of preferably about ¼ inch. Form maintainer 1218 preferably comprises distributor 1227, which distributes tension uniformly across bag 1202, which sometimes occurs, for example, when bag 1202 is under tension due to forces on connector 1220 (embodying herein, distributor means for distributing force uniformly across said bag means). Distributor 1227 preferably comprises leather, preferably leather portions which attach connector 1220 to bag 1202. Distributor 1227 preferably comprises a widening portion of leather, where the portion attaching to bag 1202 is wider than the portion attaching to connector 1220, as shown. Form maintainer 1218 preferably comprises protector 1229, which protects the containable items inside bag 1202 (embodying herein, protector means for protecting the at least one containable item). Protector 1229 preferably comprises foam. Protector 1229 preferably comprises padding. Protector 1229 preferably comprises a uniform foam padding having a thickness of preferably about ¼ inch. Upon reading the teachings of this specification, those of ordinary skill in the art will now understand that, under appropriate circumstances, considering such issues as materials, market demand, technology, cost, etc., other form maintainers, such as, for example, metal, cotton, composite, plastic, rubber, other fabrics, other materials, other reinforcers, other tension distributors, thermal blockers, fluid blockers, other compression preventers, other shapes, other elastic objects, etc., may suffice.

System 1000 preferably comprises connector 1220. Connector 1220 preferably comprises strap 1224. Connector 1220 preferably comprises elastic material. Connector 1220 preferably comprises some leather, where connector 1220 connects to bag 1202. More preferably, connector 1220 comprises a substantial amount of leather where connector 1220 connects to bag 1202, as shown. The use of leather provides added strength to bag 1202. Connector 1220 preferably comprises distributor 1227, which distributes tension uniformly across bag 1202. Alternatively, bag 1202 is sufficient to function with or without a connector 1220. Upon reading the teachings of this specification, those of ordinary skill in the art will now understand that, under appropriate circumstances, considering issues such as cost, manufacturing, container detachability, etc., other connectors, such as, for example, Velcro™, hooks, stitched and non-stitched attachers, clothing articles, etc., may suffice.

System 1000 preferably comprises connector 1220. Connector 1220 preferably comprises adjuster 1222, for tightening or loosening by adjusting, preferably, the length of straps 1224. Preferably, adjuster 1222 comprises a bracket that slides along straps 1224. Upon reading the teachings of this specification, those with ordinary skill in the art will now understand that, under appropriate circumstances, considering issues such as cost, manufacturing, materials, etc., other adjusters 1222, such as, for example, pinching adjusters, spacers, straps with greater elasticity, Velcro™, hooks, other adjusters, etc., may suffice.

System 1000 preferably comprises limiter 1228 (embodying herein, limiter means for limiting the opening ability of said bag means). Limiter 1228 preferably comprises a zipper 1250 arranged so as to prevent containable items from falling out of bag 1202. Limiter 1228 preferably comprises a zipper 1250 located across the top half of bag 1202. Limiter 1228 preferably comprises elastic material. Upon reading the teachings of this specification, those of ordinary skill in the art will now understand that, under appropriate circumstances, considering such issues as usability, market demand, technology, cost, etc., other limiter 1228 arrangements, such as, for example, elastic material connecting front portion 1210 to back portion 1212 via primary interior portion 1214, clips, Velcro™, etc., may suffice.

System 1000 preferably comprises zippers 1250. Zipper 1250 preferably comprises zipper tab 1252. Zipper 1250 preferably comprises two zipper tabs 1252 where zipper 1250 comprises accessor 1204. Zipper 1250 preferably comprises limiter 1228. Zipper 1250 preferably is structured and arranged so as to prevent containable items from falling out of bag 1202.

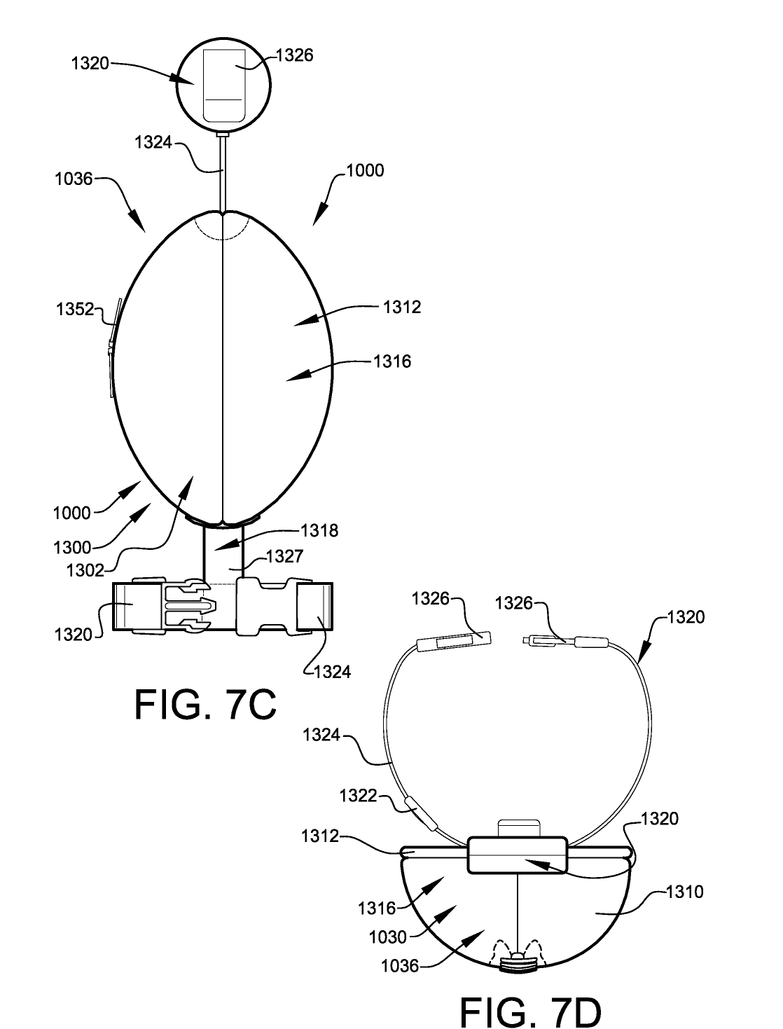

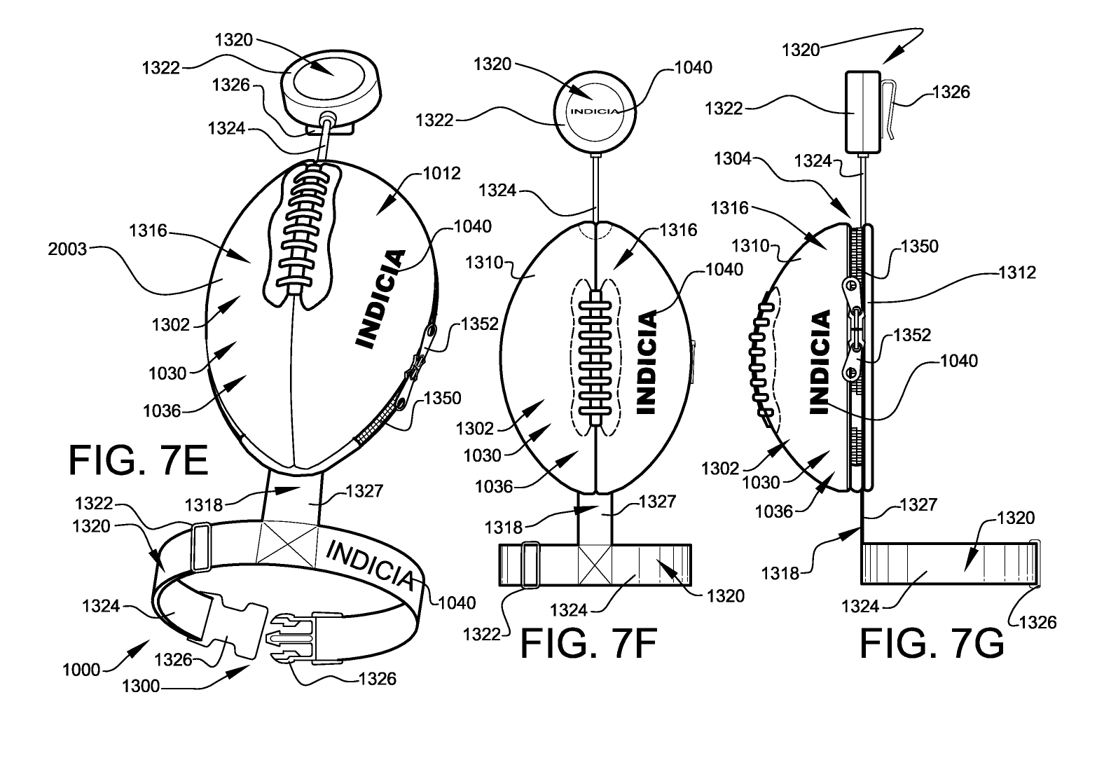

Sports ball bag system 1000 preferably comprises leg pack system 1300. Leg pack system 1300 preferably comprises leg pack bag 1302 and accessor 1304. Leg pack bag 1302 preferably comprises front portion 1310, back portion 1312, primary interior portion 1314, and primary exterior portion 1316 (embodying herein, bag means for containing the at least one containable item). Leg pack bag 1302 preferably comprises leg pack 2003, as shown in FIGS. 7A through 7G. Upon reading the teachings of this specification, those of ordinary skill in the art will now understand that, under appropriate circumstances, considering such issues as utility, fashion, technology, cost, etc., other packs and orientations, such as, for example, front packs, carriers, holders, other packs, clothing, packs on other parts of the body, etc., may suffice.

Front portion 1310 of leg pack bag 1302 preferably comprises at least one portion of sports item 1030 (embodying herein, front portion means for providing at least one front portion of said bag means). Preferably, system 1000 comprises the specific details of the sports related item represented, such as size, shape, material, color, texture, seam arrangement, symmetry, common indicia, etc. Preferably, the portion represented, projecting away from the user, is the most detailed portion of the sports item represented, as shown.

For example, a football-related sports item 1030, such as a football, would preferably comprise a portion of an actual football or replica of a football, preferably of various sizes, preferably dependent on the size of the user in light of usability, preferably shaped substantially identical to a football, preferably made of a material which looks like leather, preferably brown in color, preferably with a dimpled texture, preferably having about eight white laces in parallel, where leg pack bag 1302 is preferably horizontally and vertically symmetric to the user, with football related indicia (such as “NFL”), and a manufacturer emblem (such as Wilson™).

Back portion 1312 preferably encloses front portion 1310, resulting in leg pack bag 1302 (embodying herein, back portion means for providing at least one back portion of said bag means). Preferably, back portion 1312 is substantially flat, as shown, contoured to provide comfort and ease of use. A substantially flat back portion 1312 provides contour and comfort against the user. Preferably, back portion 1312 comprises an inexpensive, non-aggravating material. Preferably, back portion 1312 provides for comfortable wearability by the user.

System 1000 preferably comprises primary interior portion 1314, which is capable of holding containable items (embodying herein, primary interior portion means for providing at least one interior portion of said bag means). Interior portion 1314 preferably comprises liner 1319, which lines the interior of leg pack bag 1302. Liner 1319 preferably comprises a fluid blocker, preferably creating a waterproof leg pack bag 1302, which prevents saturation of containable items. Liner 1319 preferably comprises a thermal blocker, preferably creating a thermally consistent interior portion 1314, maintaining a consistent temperature for containable items. Liner 1319 preferably comprises vinyl.

System 1000 preferably comprises primary exterior portion 1316 (embodying herein, primary exterior portion means for providing at least one exterior portion of said bag means). System 1000 preferably comprises secondary interior portion 1331, which is capable of holding containable items (embodying herein, secondary interior portion means for providing at least one secondary interior portion of said bag means). Secondary interior portion 1331 preferably comprises a pocket with a zipper 1350. Secondary interior portion 1331 preferably comprises a Velcro™ pocket. System 1000 preferably comprises a pocket with a zipper 1350 and a Velcro™ pocket, as shown in FIG. 5C. System 1000 may also comprise secondary exterior portion, which may also contain containable items. Upon reading the teachings of this specification, those with ordinary skill in the art will now understand that, under appropriate circumstances, considering issues such as market demand, manufacturing, materials, cost, etc., other secondary interior portion 1331 arrangements, such as, for example, pockets, folders, snaps, buckles, tension brackets, Velcro™, multiple openings, etc., may suffice.

Accessor 1304 is preferably located between the front portion 1310 and the back portion 1312, as shown (embodying herein, accessor means for accessing said interior portion means of said bag means). Accessor 1304 preferably comprises zipper 1350, as shown. Preferably, accessor 1304 comprises zipper tab 1352, as shown. Preferably, system 1000 comprises a zipper 1350 that extends about 50% or more around the circumference of bag 1012, as shown in FIG. 5C. Upon reading the teachings of this specification, those with ordinary skill in the art will now understand that, under appropriate circumstances, considering issues such as market demand, manufacturing, materials, cost, etc., other accessor arrangements, such as, for example, snaps, buckles, tension brackets, Velcro™, other locations for accessor 1304, zippers that extend about 50% or less around the circumference of the bag, multiple openings, etc., may suffice.

System 1000 preferably comprises form maintainer 1318 (embodying herein, form maintainer means for maintaining the form of said bag means), as shown. Form maintainer 1318 preferably comprises an actual sports item 1030, where the material sports item 1030 is made out of sufficiently maintains the form of sports item 1030. Form maintainer 1318 preferably comprises reinforcer 1325, which reinforces the form of bag 1302, which sometimes occurs when, for example, bag 1302 is under compression (embodying herein, reinforcer means for reinforcing the form of said bag means). Reinforcer 1325 preferably comprises foam. Reinforcer 1325 preferably comprises padding. Reinforcer 1325 preferably comprises a uniform foam padding having a thickness of preferably about ¼ inch. Form maintainer 1318 preferably comprises distributor 1327, which distributes tension uniformly across bag 1302, which sometimes occurs, for example, when bag 1302 is under tension due to forces on connector 1320 (embodying herein, distributor means for distributing force uniformly across said bag means). Distributor 1327 preferably comprises leather, preferably leather portions which attach connector 1320 to leg pack bag 1302. Distributor 1327 preferably comprises a widening portion of leather, where the portion attaching to bag 1302 is wider than the portion attaching to connector 1320, as shown. Form maintainer 1318 preferably comprises protector 1329, which protects the containable items inside bag 1302 (embodying herein, protector means for protecting the at least one containable item). Protector 1329 preferably comprises foam. Protector 1329 preferably comprises padding. Protector 1329 preferably comprises a uniformly one-quarter of an inch thick foam padding, as shown. Upon reading the teachings of this specification, those of ordinary skill in the art will now understand that, under appropriate circumstances, considering such issues as materials, market demand, technology, cost, etc., other form maintainers, such as, for example, metal, cotton, composite, plastic, rubber, other fabrics, other materials, other reinforcers, other tension distributors, thermal blockers, fluid blockers, other compression preventers, other shapes, other elastic objects, etc., may suffice.

System 1000 preferably comprises connector 1320. Connector 1320 preferably comprises strap 1324. Connector 1320 preferably comprises buckle 1326. Connector 1320 preferably comprises elastic material. Connector 1320 preferably comprises some leather, where connector 1320 connects to bag 1302. Preferably, connector 1320 comprises leather where connector 1320 connects to leg pack bag 1302, as shown. Connector 1320 preferably comprises distributor 1327, which distributes tension uniformly across bag 1302. Alternatively, leg pack bag 1302 is sufficient to function with or without a connector 1320. Upon reading the teachings of this specification, those of ordinary skill in the art will now understand that, under appropriate circumstances, considering issues such as cost, manufacturing, container detachability, etc., other connectors, such as, for example, Velcro™, hooks, stitched and non-stitched attachers, clothing articles, etc., may suffice.

System 1000 preferably comprises connector 1320. Connector 1320 preferably comprises adjuster 1322, for tightening or loosening by adjusting, preferably, the length of straps 1324. Preferably, adjuster 1322 is a traditional adjuster, comprising a bracket that slides along straps 1324. Upon reading the teachings of this specification, those with ordinary skill in the art will now understand that, under appropriate circumstances, considering issues such as cost, manufacturing, materials, etc., other adjusters 1322, such as, for example, pinching adjusters, spacers, straps with greater elasticity, Velcro™, hooks, non-traditional adjusters, etc., may suffice.

System 1000 preferably comprises limiter 1328 (embodying herein, limiter means for limiting the opening ability of said bag means). Limiter 1328 preferably comprises a zipper 1350 arranged so as to prevent containable items from falling out of bag 1302. Limiter 1328 preferably comprises a zipper 1350 located across the top half of leg pack bag 1302. Limiter 1328 preferably comprises elastic material. Upon reading the teachings of this specification, those of ordinary skill in the art will now understand that, under appropriate circumstances, considering such issues as usability, market demand, technology, cost, etc., other limiter 1328 arrangements, such as, for example, elastic material connecting front portion 1310 to back portion 1312 via primary interior portion 1314, clips, Velcro™, etc., may suffice.

System 1000 preferably comprises zippers 1350. Zipper 1350 preferably comprises zipper tab 1352. Zipper 1350 preferably comprises two zipper tabs 1352 where zipper 1350 comprises accessor 1304. Zipper 1350 is preferably comprises limiter 1328. Zipper 1350 preferably is structured and arranged so as to prevent containable items from falling out of leg pack bag 1302.

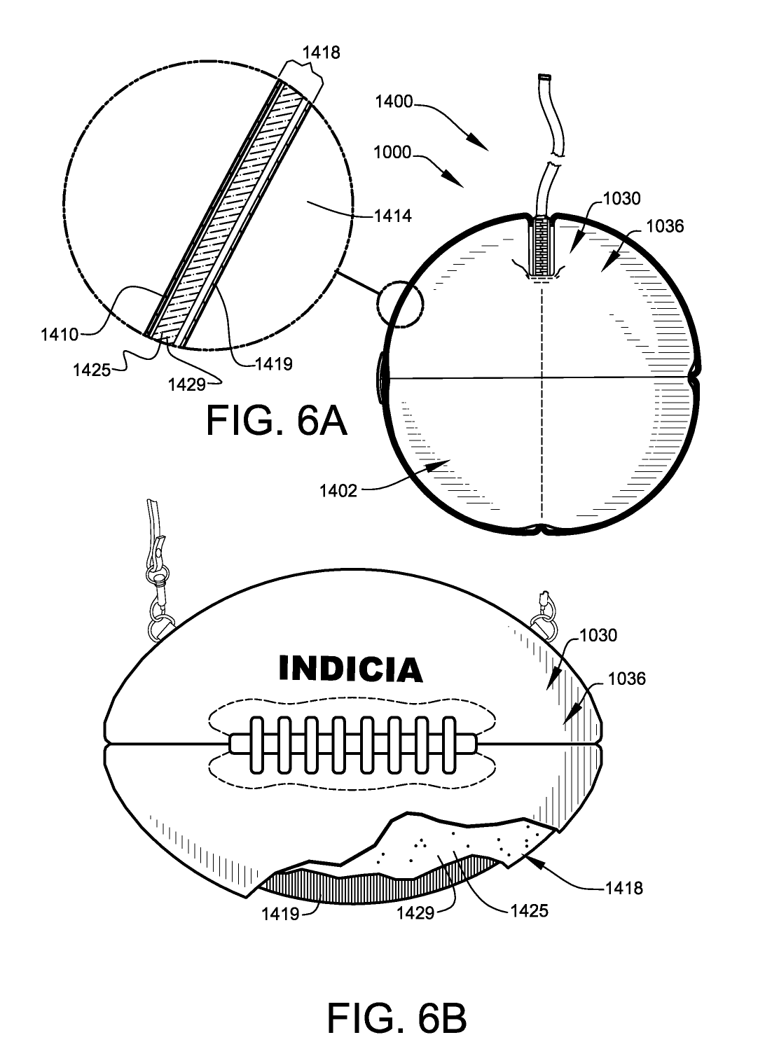

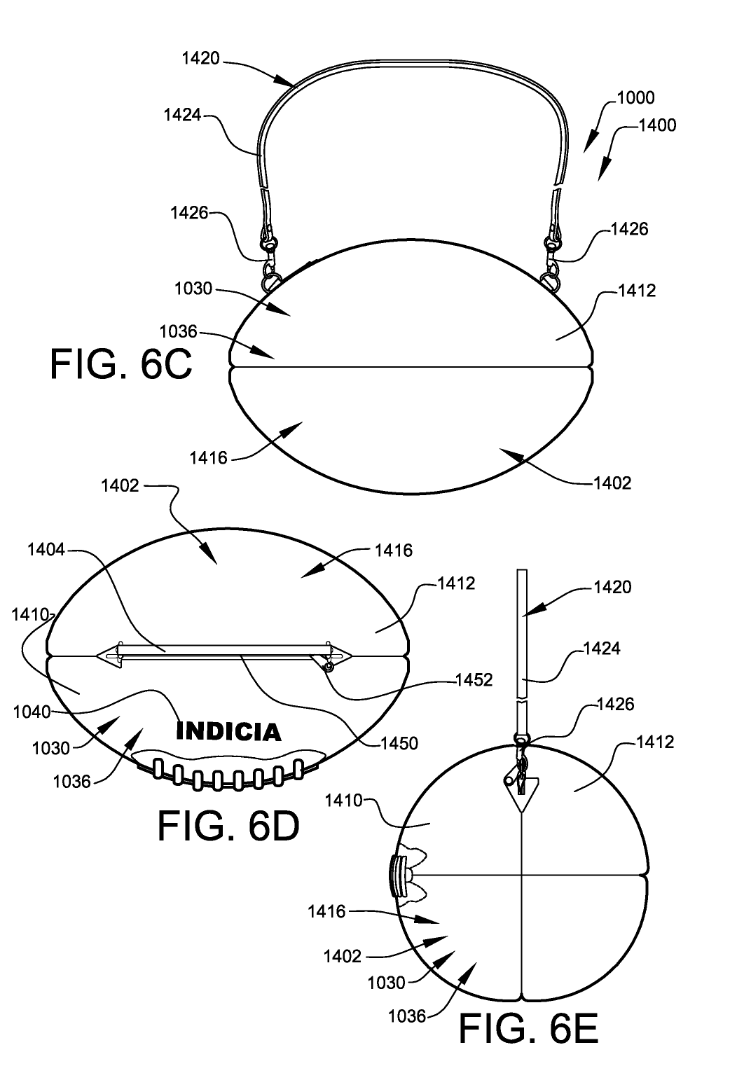

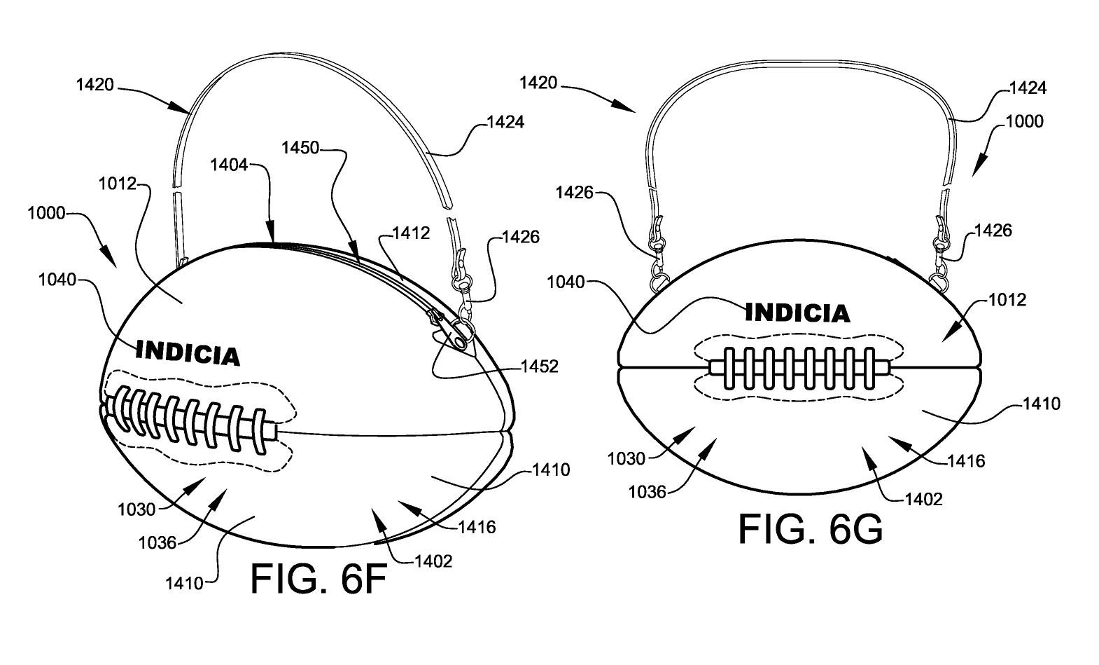

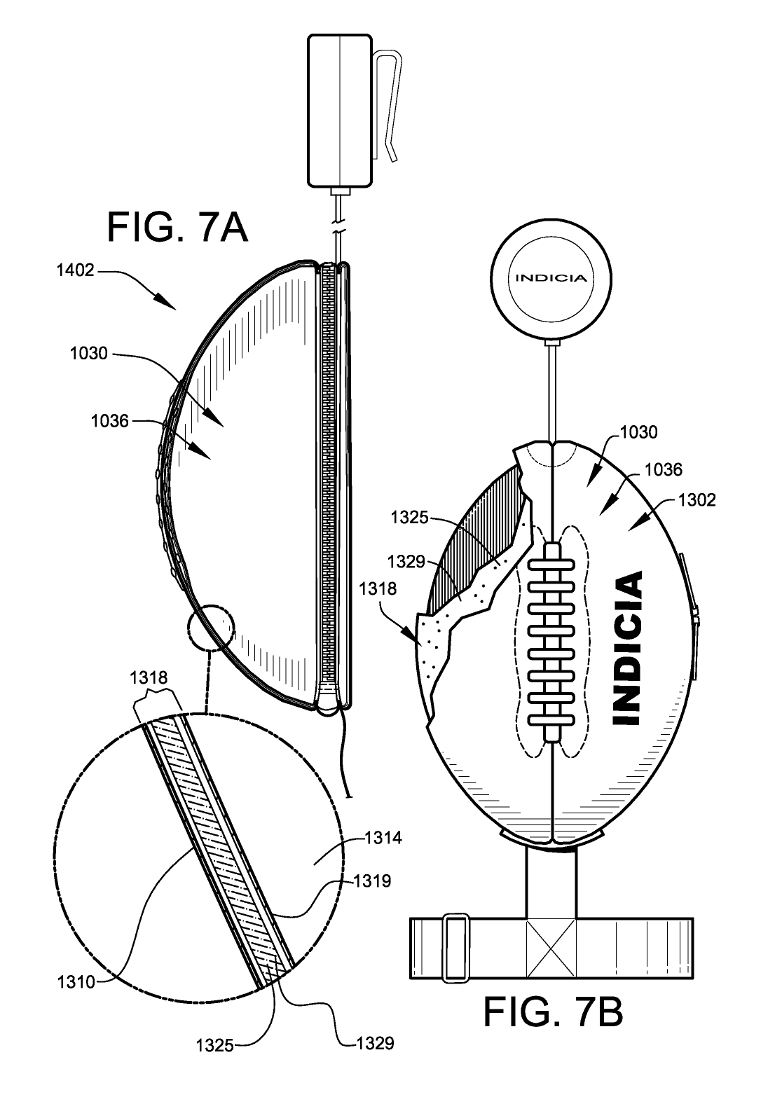

FIG. 6A is a blown-up cross-section view of a football tote bag, having detachable handles, of the sports ball bag system according to a preferred embodiment of the present invention. Sports ball bag system 1000 preferably comprises tote pack system 1400. System 1400 preferably comprises tote pack bag 1402 and accessor 1404. Tote pack bag 1402 preferably comprises front portion 1410, back portion 1412, primary interior portion 1414, and primary exterior portion 1416 (embodying herein, bag means for containing the at least one containable item). Tote pack bag 1402 preferably comprises tote pack 2002, as shown in FIGS. 6A through 6G. Upon reading the teachings of this specification, those of ordinary skill in the art will now understand that, under appropriate circumstances, considering such issues as utility, fashion, technology, cost, etc., other packs and orientations, such as, for example, front packs, carriers, holders, other packs, clothing, packs on other parts of the body, etc., may suffice.

Front portion 1410 preferably comprises at least one portion of sports item 1030 (embodying herein, front portion means for providing at least one front portion of said bag means). Preferably, system 1000 comprises the specific details of the sports related item represented, such as size, shape, material, color, texture, seam arrangement, symmetry, common indicia, etc. Preferably, the portion represented, projecting away from the user, is the most detailed portion of the sports item represented, as shown.

For example, a football-related sports item 1030, such as a football, would preferably comprise a portion of an actual football or replica of a football, preferably of various sizes, preferably dependent on the size of the user in light of usability, preferably shaped substantially identical to a football, preferably made of a material which looks like leather, preferably brown in color, preferably with a dimpled texture, preferably having about eight white laces in parallel, where bag 1402 is preferably horizontally and vertically symmetric to the user, with football related indicia (such as “NFL”), and a manufacturer emblem (such as Wilson™).

Back portion 1412 preferably encloses front portion 1410, resulting in bag 1402 (embodying herein, back portion means for providing at least one back portion of said bag means). Preferably, back portion 1412 is substantially flat, as shown, contoured to provide comfort and ease of use. A substantially flat back portion 1412 provides contour and comfort against the user. Preferably, back portion 1412 comprises an inexpensive, non-aggravating material. Preferably, back portion 1412 provides for comfortable wearability by the user.

System 1000 preferably comprises primary interior portion 1414, which is capable of holding containable items (embodying herein, primary interior portion means for providing at least one interior portion of said bag means). Interior portion 1414 preferably comprises liner 1419, which lines the interior of bag 1402. Liner 1419 preferably comprises a fluid blocker, preferably creating a waterproof tote pack bag 1402, which prevents saturation of containable items. Liner 1419 preferably comprises a thermal blocker, preferably creating a thermally consistent interior portion 1414, maintaining a consistent temperature for containable items. Liner 1419 preferably comprises vinyl.

System 1000 preferably comprises primary exterior portion 1416 (embodying herein, primary exterior portion means for providing at least one exterior portion of said bag means). System 1000 preferably comprises secondary interior portion 1431, which is capable of holding containable items (embodying herein, secondary interior portion means for providing at least one secondary interior portion of said bag means). Secondary interior portion 1431 preferably comprises a pocket with a zipper 1450. Secondary interior portion 1431 preferably comprises a Velcro™ pocket. System 1000 preferably comprises a pocket with a zipper 1450 and a Velcro™ pocket, as shown in FIG. 5C. System 1000 may also comprise secondary exterior portion, which may also contain containable items. Upon reading the teachings of this specification, those with ordinary skill in the art will now understand that, under appropriate circumstances, considering issues such as market demand, manufacturing, materials, cost, etc., other secondary interior portion 1431 arrangements, such as, for example, pockets, folders, snaps, buckles, tension brackets, Velcro™, multiple openings, etc., may suffice.

Accessor 1404 is preferably located between the front portion 1410 and the back portion 1412, as shown (embodying herein, accessor means for accessing said interior portion means of said bag means). Accessor 1404 preferably comprises zipper 1450, as shown. Preferably, accessor 1404 comprises zipper tab 1452, as shown. Preferably, system 1000 comprises a zipper 1450 that extends about 50% or more around the circumference of bag 1012, as shown in FIG. 5C. Upon reading the teachings of this specification, those with ordinary skill in the art will now understand that, under appropriate circumstances, considering issues such as market demand, manufacturing, materials, cost, etc., other accessor arrangements, such as, for example, snaps, buckles, tension brackets, Velcro™, other locations for accessor 1404, zippers that extends about 50% or less around the circumference of the bag, multiple openings, etc., may suffice.

System 1000 preferably comprises form maintainer 1418 (embodying herein, form maintainer means for maintaining the form of said bag means), as shown. Form maintainer 1418 preferably comprises an actual sports item 1030, where the material sports item 1030 is made out of sufficiently maintains the form of sports item 1030. Form maintainer 1418 preferably comprises reinforcer 1425, which reinforces the form of tote pack bag 1402, which sometimes occurs when, for example, tote pack bag 1402 is under compression (embodying herein, reinforcer means for reinforcing the form of said bag means). Reinforcer 1425 preferably comprises foam. Reinforcer 1425 preferably comprises padding. Reinforcer 1425 preferably comprises a uniformly one-quarter of an inch thick foam padding. Form maintainer 1418 preferably comprises distributor 1427, which distributes tension uniformly across bag 1402, which sometimes occurs, for example, when tote pack bag 1402 is under tension due to forces on connector 1420 (embodying herein, distributor means for distributing force uniformly across said bag means). Distributor 1427 preferably comprises leather, preferably leather portions which attach connector 1420 to tote pack bag 1402. Distributor 1427 preferably comprises a widening portion of leather, where the portion attaching to tote pack bag 1402 is wider than the portion attaching to connector 1420, as shown. Form maintainer 1418 preferably comprises protector 1429, which protects the containable items inside tote pack bag 1402 (embodying herein, protector means for protecting the at least one containable item). Protector 1429 preferably comprises foam. Protector 1429 preferably comprises padding. Protector 1429 preferably comprises a uniformly one-quarter of an inch thick foam padding, as shown. Upon reading the teachings of this specification, those of ordinary skill in the art will now understand that, under appropriate circumstances, considering such issues as materials, market demand, technology, cost, etc., other form maintainers, such as, for example, metal, cotton, composite, plastic, rubber, other fabrics, other materials, other reinforcers, other tension distributors, thermal blockers, fluid blockers, other compression preventers, other shapes, other elastic objects, etc., may suffice.

System 1000 preferably comprises connector 1420. Connector 1420 preferably comprises strap 1424. Connector 1420 preferably comprises buckle 1426. Connector 1420 preferably comprises elastic material. Connector 1420 preferably comprises some leather, where connector 1420 connects to bag 1402. Preferably, connector 1420 comprises leather where connector 1420 connects to tote pack bag 1402, as shown. Connector 1420 preferably comprises distributor 1427, which distributes tension uniformly across bag 1402. Alternatively, tote pack bag 1402 is sufficient to function with or without a connector 1420. Upon reading the teachings of this specification, those of ordinary skill in the art will now understand that, under appropriate circumstances, considering issues such as cost, manufacturing, container detachability, etc., other connectors, such as, for example, Velcro™, hooks, stitched and non-stitched attachers, clothing articles, etc., may suffice.

System 1000 preferably comprises connector 1420. Connector 1420 preferably comprises adjuster 1422, for tightening or loosening by adjusting, preferably, the length of straps 1424. Preferably, adjuster 1422 is a traditional adjuster, comprising a bracket that slides along straps 1424. Upon reading the teachings of this specification, those with ordinary skill in the art will now understand that, under appropriate circumstances, considering issues such as cost, manufacturing, materials, etc., other adjusters 1422, such as, for example, pinching adjusters, spacers, straps with greater elasticity, Velcro™, hooks, non-traditional adjusters, etc., may suffice.

System 1000 preferably comprises limiter 1428 (embodying herein, limiter means for limiting the opening ability of said bag means). Limiter 1428 preferably comprises a zipper 1450 arranged so as to prevent containable items from falling out of tote pack bag 1402. Limiter 1428 preferably comprises a zipper 1450 located across the top half of tote pack bag 1402. Limiter 1428 preferably comprises elastic material. Upon reading the teachings of this specification, those of ordinary skill in the art will now understand that, under appropriate circumstances, considering such issues as usability, market demand, technology, cost, etc., other limiter 1428 arrangements, such as, for example, elastic material connecting front portion 1410 to back portion 1412 via primary interior portion 1414, clips, Velcro™, etc., may suffice.

System 1000 preferably comprises zippers 1450. Zipper 1450 preferably comprises zipper tab 1452. Zipper 1450 preferably comprises two zipper tabs 1452 where zipper 1450 comprises accessor 1404. Zipper 1450 is preferably comprises limiter 1428. Zipper 1450 preferably is structured and arranged so as to prevent containable items from falling out of tote pack bag 1402.

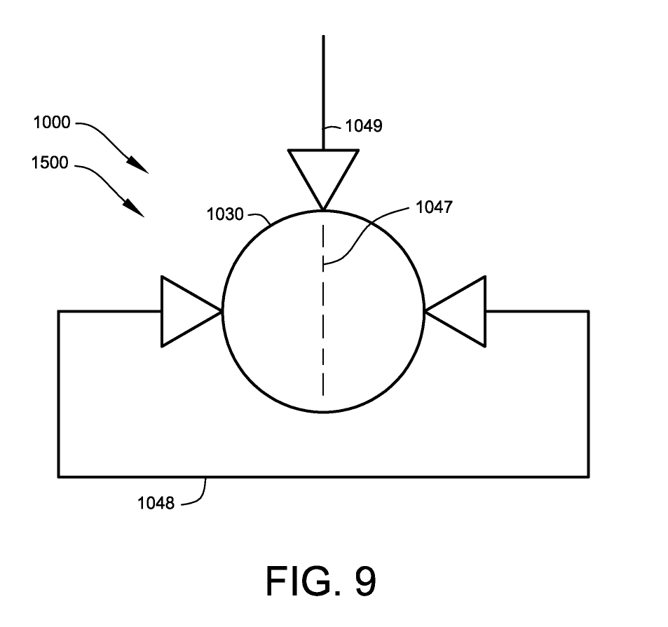

FIG. 9 is a perspective view of a holder and cutter according to a preferred embodiment of the present invention. As shown in FIG. 9, sports ball bag system 1000 preferably comprises manufacturing system 1500, preferably comprising holder 1048 (embodying herein, holder means for holding the at least one three-dimensional representation of at least one item necessary to at least one sports contest). Holder 1048 is preferably a vise. Upon reading the teachings of this specification, those of ordinary skill in the art will now understand that, under appropriate circumstances, considering such issues as technique, safety, technology, cost, etc., other holder arrangements, such as, for example, people, clamps, other forms of tension, pressure, other non-vises, etc., may suffice.

In addition, as shown in FIG. 9, manufacturing system 1500 preferably comprises cutter 1049 (embodying herein, cutter means for cutting the at least one three-dimensional representation of at least one item necessary to at least one sports contest). Holder 1048 preferably holds sports item 1030 while cutter 1049 cuts sports item 1030 along a cutting path 1047, as shown. Cutter 1049 is preferably a saw. Upon reading the teachings of this specification, those of ordinary skill in the art will now understand that, under appropriate circumstances, considering such issues as technique, safety, technology, cost, etc., other cutter arrangements, such as, for example, lasers, chemicals, other molecule separators, other non-saws, etc., may suffice.

System 1000 preferably utilizes a partially defective sports item 1030, such that a company that manufacturers sports-related items, sports gear, sports equipment, etc., are using a sports item 1030 that will otherwise be destroyed because it would be defective for its originally intended use. Preferably, sports ball bag system 1000 utilizes a sports item 1030 that is essentially about one-half of a whole three-dimensional representation of an item necessary to a sports contest, so as to provide two of sports item 1030 for every whole three-dimensional representation of an item necessary to a sports contest.

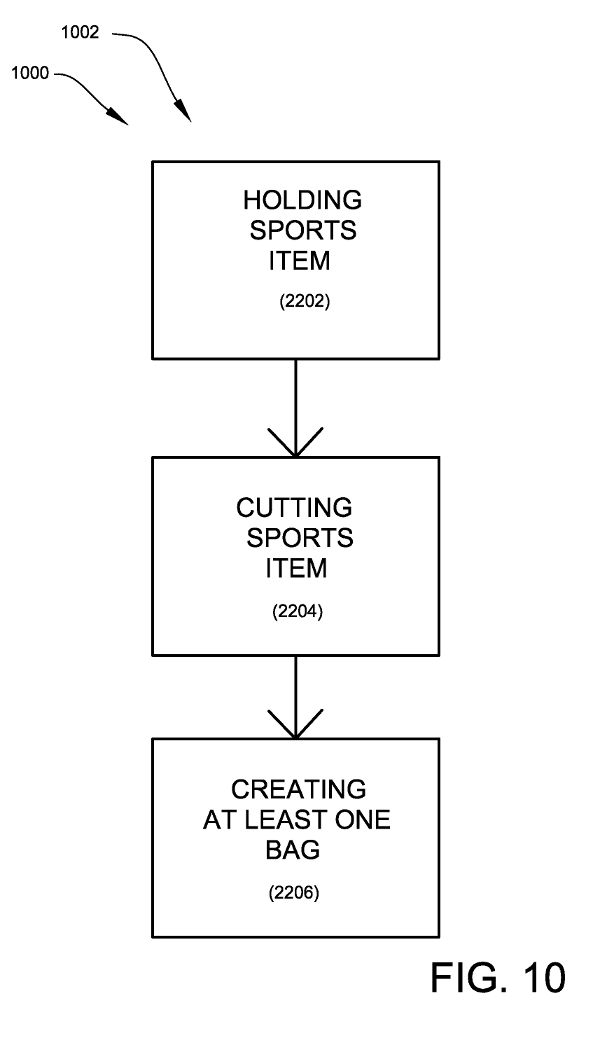

FIG. 10 is a diagrammatic view of a manufacturing method according to a preferred embodiment of the present invention. As shown in FIG. 10, sports ball bag system 1000 preferably comprises method 1002, related to at least one three-dimensional representation of at least one item necessary to at least one sports contest 1030, comprising the steps of: holding at least one three-dimensional representation of at least one item necessary to at least one sports contest (step 2202); and cutting, while being held, such at least one three-dimensional representation of at least one item necessary to at least one sports contest (step 2204). Preferably, method 1002 further comprises creating a bag utilizing such at least one three-dimensional representation of at least one item necessary to at least one sports contest (step 2206). Preferably, such at least one three-dimensional representation of at least one item necessary to at least one sports contest is at least one sports ball. Preferably, method 1002 comprises creating a material pattern. Preferably, method 1002 comprises cutting a patterned material out of leather. Preferably, method 1002 comprises cutting a patterned material out of foam. Preferably, method 1002 comprises sewing patterned materials together, preferably by hand.

Although applicant has described applicant's preferred embodiments of this invention, it will be understood that the broadest scope of this invention includes modifications such as diverse shapes, sizes, and materials. Such scope is limited only by the below claims as read in connection with the above specification. Further, many other advantages of applicant's invention will be apparent to those skilled in the art from the above descriptions and the below claims.

What is claimed is:

1) A method of manufacturing a bag, such bag comprising at least one three-dimensional representation of at least one item necessary to at least one sports contest, said method comprising the steps of:
a) holding at least one three-dimensional representation of at least one item necessary to at least one sports contest;
b) cutting, while being held, such at least one three-dimensional representation of at least one item necessary to at least one sports contest; and
c) creating at least one bag from such cut at least one three-dimensional representation of at least one item necessary to at least one sports contest.

2) The method, according to claim 1, wherein the at least one three-dimensional representation of at least one item necessary to at least one sports contest comprises essentially about one-half of a three-dimensional representation of at least one item necessary to at least one sports contest, so as to provide two of the essentially about one-half of a three-dimensional representation of at least one item necessary to at least one sports contest for every whole three-dimensional representation of an item necessary to a sports contest.

3) A product manufactured according to the method of claim 1, such product comprising
a) at least one bag structured and arranged to bag at least one containable item;
b) wherein said at least one bag comprises
i) at least one front portion,
ii) at least one back portion,
iii) at least one primary interior portion,
iv) at least one primary exterior portion, and
v) at least one accessor structured and arranged to provide accessibility to said at least one primary interior portion of said at least one bag;
c) wherein said at least one front portion comprises at least one portion of at least one three-dimensional representation of at least one item necessary to at least one sports contest;
d) wherein said at least one back portion is structured and arranged to enclose said at least one front portion; and
e) wherein said at least one bag comprises at least one form maintainer structured and arranged to maintain at least one form of said at least one bag.

4) The product, according to claim 3,
a) wherein said at least one form maintainer comprises
i) at least one connector structured and arranged to connect said at least one bag to at least one user,
ii) at least one distributor structured and arranged to distribute tension uniformly along at least one edge of said at least one bag,
iii) at least one reinforcer structured and arranged to reinforce the at least one form of said at least one bag, and
iv) at least one protector structured and arranged to protect the at least one containable item;
b) wherein said at least one connector comprises
i) at least one adjuster structured and arranged to provide adjustability of position of said at least one bag on the user;
ii) at least one strap structured and arranged to secure said at least one bag to the user; and
iii) at least one buckle; and
c) at least one limiter structured and arranged to limit at least one opening ability of said at least one bag;
d) wherein said at least one limiter comprises at least one zipper structured and arranged to limit the at least one opening ability of said at least one bag.

5) The product according to claim 4 wherein said at least one protector comprises foam material having a thickness of about ¼ inch.

6) The product according to claim 3 wherein said at least one bag consists essentially of about one whole at least one three-dimensional representation of at least one item necessary to at least one sports contest.

7) The product according to claim 3 wherein said at least one three-dimensional representation of at least one item necessary to at least one sports contest comprises essentially about one-half of at least one item resembling at least one sports ball.

8) The product according to claim 3 wherein said at least one three-dimensional representation of at least one item necessary to at least one sports contest comprises at least one item resembling at least one sports ball.

9) The product according to claim 8 wherein said at least one three-dimensional representation of at least one item necessary to at least one sports contest comprises at least one item resembling at least one football.

10) The product according to claim 8, wherein said at least one three-dimensional representation of at least one item necessary to at least one sports contest comprises at least one item resembling at least one basketball.

11) The product according to claim 8 wherein said at least one three-dimensional representation of at least one item necessary to at least one sports contest comprises at least one item resembling at least one soccer ball.

12) The product according to claim 8 wherein said at least one three-dimensional representation of at least one item necessary to at least one sports contest comprises at least one item resembling at least one baseball.

13) The product according to claim 8 wherein said at least one three-dimensional representation of at least one item necessary to at least one sports contest comprises at least one item resembling at least one tennis ball.

14) The product according to claim 8 wherein said at least one three-dimensional representation of at least one item necessary to at least one sports contest comprises at least one item resembling at least one volleyball.

15) The product according to claim 3 wherein said at least one bag comprises at least one fanny pack.

16) The product according to claim 3 wherein said at least one bag comprises at least one backpack.

17) The product according to claim 3 wherein said at least one bag comprises at least one leg pack.

18) The product according to claim 3 wherein said at least one bag comprises at least one tote pack.

19) The product according to claim 3 further comprising at least one indicia.

20) The product according to claim 3 wherein said at least one bag comprises at least one secondary interior portion structured and arranged to contain the at least one containable item.
